(19) United States
(12) Patent Application Publication
(10) Pub. No.: US 2011/0307688 A1
(43) Pub. Date: Dec. 15, 2011

(54) SYNTHESIS SYSTEM FOR PIPELINED DIGITAL CIRCUITS

(75) Inventors: Eriko Nurvitadhi, Pittsburgh, PA (US); James C. Hoe, Pittsburgh, PA (US)

(73) Assignee: Carnegie Mellon University, Pittsburgh, PA (US)

(21) Appl. No.: 13/158,081

(22) Filed: Jun. 10, 2011

Related U.S. Application Data
(60) Provisional application No. 61/397,330, filed on Jun. 10, 2010.

(51) Int. Cl. G06F 9/38

(52) U.S. Cl. 712/219; 712/E09.045

(57) ABSTRACT

Computer-implemented methods and systems for synthesizing a hardware description for a pipelined datapath for a digital circuit. A transactional datapath specification framework and a transactional design automation system automatically synthesize pipeline implementations. The transactional datapath specification framework captures an abstract datapath, whose execution semantics is interpreted as a sequence of “transactions” where each transaction reads the state values left by the preceding transaction and computes a new set of state values to be seen by the next transaction. The transactional datapath specification framework exposes sufficient information about state accesses that can occur in a datapath, which is necessary for performing precise data hazards analysis, and eventually pipeline synthesis.

### PRIORITY CLAIM

The present application claims priority to U.S. provisional application Ser. No. 61/397,330, entitled “Automatic pipeline synthesis from transactional datapath specifications,” filed Jun. 10, 2010, which is incorporated herein by reference in its entirety.

### BACKGROUND

Pipelining is a widely applied microarchitecture performance optimization for digital electronic circuit. Starting from a non-pipelined datapath, pipelining divides the combinational paths into “stages” separated by pipeline registers, thereby reducing the critical path delay and increasing the frequency. To translate this increased frequency to throughput performance, however, the sequence of operations that was previously iterated one-after-another on the non-pipelined datapath must be overlapped in their executions across the different pipeline stages. When a younger operation depends on the state-update of an older, not-yet-finished operation still in flight in the pipeline, a read-after-write (RAW) hazard arises. To observe the correct state value, the younger operation can stall for the older operation to complete execution and update the state. Forwarding (i.e., bypassing) and speculation are well-known performance optimizations that reduce the number of pipeline stalls by allowing early resolution of RAW hazards. Pipelining a datapath by hand is tedious and error prone, as it requires the designer to reason about subtle corner cases when sequentially dependent operations are processed concurrently by the different pipeline stages.

### SUMMARY

In one general aspect, the present invention provides an abstract, transactional specification framework and its accompanying synthesis tool to facilitate the development of in-order pipelined designs. In the description to follow, the transactional specification is often referred to as “T-spec” for convenience and the synthesis tool is often referred to as “T-piper” for convenience. Using T-spec and T-piper, a digital circuit designer only needs to be concerned with capturing in T-spec a non-pipelined version of the datapath that performs a set of next-state compute operations, or a transaction, one at a time. In various embodiments, to arrive at a pipelined implementation, using designer-specified boundaries for pipeline stages, T-piper analysis informs the designer of the available opportunities for applying forwarding and speculation to resolve hazards. Then, based on the designer's selection of which forwarding and speculation optimizations to include, T-piper generates a hardware description for the pipeline datapath, such as a Register Transfer Level (RTL) Verilog implementation of the desired pipeline datapath, which preserves the transactional semantics of the T-spec datapath. Starting from the same T-spec, the designer can rapidly explore the pipeline design space by submitting different pipeline configurations to T-piper.

These and other benefits of the present invention will be apparent from the description that follows.

### FIGURES

Various embodiments of the present invention are described herein by way of example in conjunction with the following figures, wherein:

FIG. 1 is block diagram of a computer system for synthesizing a hardware description for the pipeline datapath according to various embodiments of the present invention;

FIG. 2A is a diagram of a transaction abstraction of a datapath;

FIG. 2B is a diagram of an example datapath;

FIG. 3 provides an example of a transactional specification (T-spec) according to various embodiments of the present invention;

FIG. 4 is a diagram of a process flow for the computer system of claim 1 according to various embodiments of the present invention;

FIGS. 5A-C illustrate data hazard analysis and resolution according to various embodiments of the present invention;

FIG. 6 provides a forwarding-points extraction algorithm according to various embodiments of the present invention;

FIGS. 7A-C illustrate a forwarding-points extraction example according to various embodiments of the present invention;

FIG. 7D illustrates a pipeline model according to various embodiments of the present invention;

FIG. 8 illustrates pipeline communication modes according to various embodiments of the present invention;

FIG. 9 illustrates pipeline internals according to various embodiments of the present invention;

FIGS. 10A-B illustrate multi-cycle and operation modes according to various embodiments of the present invention;

FIG. 11 illustrates an example of an online user interface for specifying the transactional specification, pipeline boundaries and forwarding scheme to be used in the pipeline synthesis according to various embodiments of the present invention;

FIG. 12 illustrates a x86 T-spec and pipeline used in a study described in the patent application;

FIG. 13 illustrates an evaluation framework according to various embodiments of the present invention;

FIGS. 14A-B provide results from a study showing x86 cost-performance tradeoff;

FIGS. 15A-B illustrate an application-specific processor customization approach according to various embodiments of the present invention;

FIGS. 16A-C provide implementation costs for a x86 processor study;

FIGS. 17A-C provide performance costs for a x86 processor study;

FIGS. 18A-C illustrate a verification example;

FIG. 19 illustrates pipeline intervals according to various embodiments of the present invention;

FIG. 20 provides an algorithm to abstract the PstageBlocks by a minimum number of UFs according to various embodiments of the present invention;

FIGS. 21A-D illustration verifying pipelines with stalling, forwarding, and speculation execution according to various embodiments of the present invention;

FIGS. 22A-B provide Verilog and SMV excerpts from the verification example in FIG. 21B according to various embodiments of the present invention; and

FIG. 23 provides SMV excerpts for the correctness properties from the example of FIG. 21B according to various embodiments of the present invention.

### DESCRIPTION

In one embodiment, this patent application discloses a transactional datapath specification framework (e.g., T-spec) and a transactional design automation system (e.g., T-piper) to automatically synthesize and formally verify in-order pipeline implementations from it. The transactional datapath specification framework makes the pipeline synthesis problem solvable by capturing an abstract datapath, whose execution semantics is interpreted as a sequence of “transactions” where each transaction reads the state values left by the preceding transaction and computes a new set of state values to be seen by the next transaction. The transactional datapath specification framework exposes sufficient information about state accesses that can occur in a datapath, which is necessary for performing precise data hazards analysis, and eventually pipeline synthesis. Furthermore, the transactional datapath specification framework also makes functional verification between the T-spec datapath and the synthesized pipeline implementation natural to do.

Prior studies that have proposed automated pipeline synthesis to alleviate the manual effort of pipeline development are mentioned in E. Nurvitadhi, J. C. Hoe, T. Kam, S. L. Lu, “Automatic Pipelining from Transactional Datapath Specifications”, Design, Automation, and Test in Europe (DATE), 2010, which is incorporated herein by reference in its entirety. Prior works that describe both automatic synthesis of in-order pipelines and multithreaded processor pipelines for FPGA prototyping are noted in E. Nurvitadhi, J. C. Hoe, S. L. Lu, T. Kam, “Automatic Multithreaded Pipeline Synthesis from Transactional Datapath Specifications”, Design Automation Conference (DAC), 2010, which is also incorporated herein by reference in its entirety. Also incorporated by reference in its entirety is Eriko Nurivitadhi's thesis, “Automatic Pipeline Synthesis and Formal Verification from Transactional Datapath Specifications,” Carnegie Mellon University, Pittsburgh, Pa., December 2010.

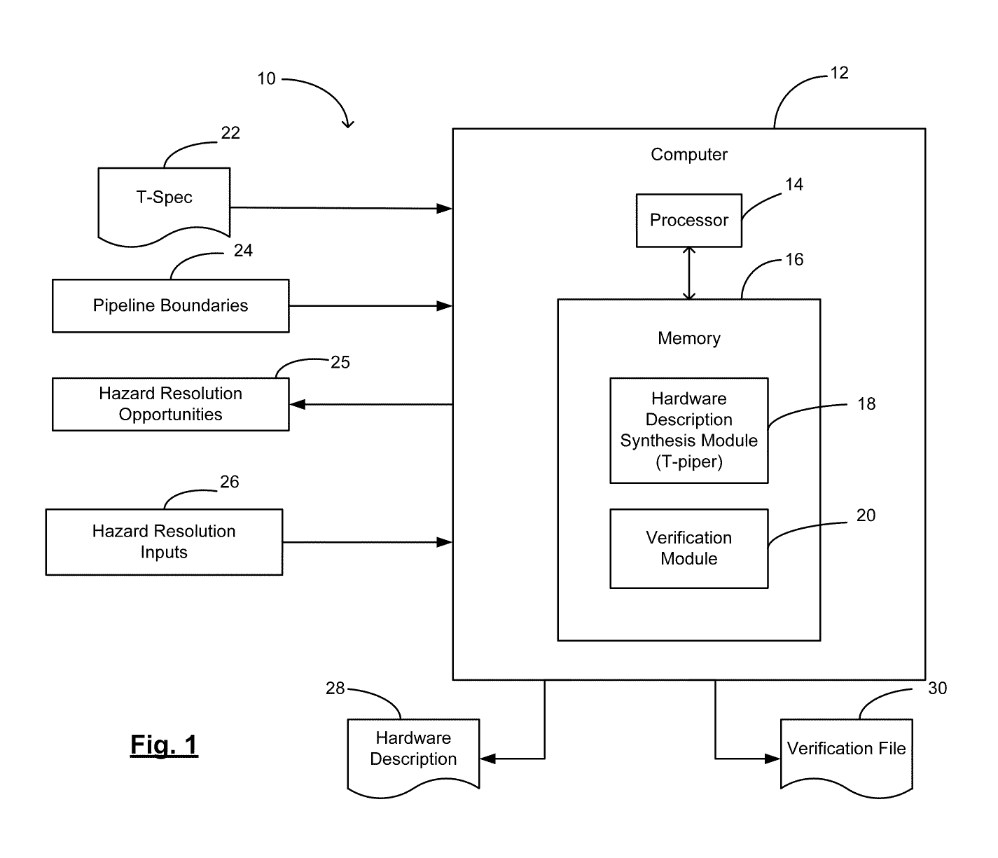

FIG. 1 is a block diagram of a computer system 10 for synthesizing and verifying a pipeline datapath for a digital circuit according to various embodiments of the present invention. The computer system 10 may comprise one or more networked computer devices 12, such as a server(s), a personal computer(s), a desktop computer(s), a laptop computer(s), a workstation(s), a mainframe computer, or processor-based computing device. The computer device may comprise one or more processors 14 and one or more memory units 16. For convenience, only one processor 14 and only one memory unit 16 are shown in FIG. 1. The processor 14 may comprise, for example, a central processing unit or a microprocessor, or another other suitable instruction-processing circuit. The memory unit 16 may comprise primary (e.g., RAM or ROM) and/or secondary computer memory (flash memory, hard disk drive, CD or DVD ROM, etc.).

As shown in FIG. 1, the memory unit 16 may comprise a hardware description synthesis module 18 and a verification module 20. The modules 18-20 may be implemented as software code stored by the memory 16 and executed by the processor 14. As described in more detail below, when the processor 14 executes the hardware description synthesis module 18, the computer 12 is caused to generate a hardware description 28 for the pipeline datapath based on a transactional specification 22 for the datapath as well as other inputs, such as pipeline boundary data 24 for the pipelined datapath and hazard resolution inputs 26 for resolving data hazards in the datapath. As mentioned previously, the transactional specification 22 is often referred to as “T-spec” herein for convenience and the synthesis tool, or hardware description synthesis module 18, is often referred to as “T-piper.” When the processor 14 executes the verification module 20, the computer 12 is caused to verify the hardware description for the pipeline datapath generated by T-piper 18.

In various embodiments, T-spec 22 makes the pipeline synthesis problem solvable. T-spec can capture an abstract datapath, whose execution semantics is interpreted by T-piper 18 as a sequence of “transactions,” where each transaction reads the state values left by the preceding transaction and computes a new set of state values to be seen by the next transaction. T-spec may expose sufficient information about state accesses that can occur in a datapath, which is necessary for performing precise data hazards analysis, and eventually pipeline synthesis. Additionally, T-spec can make functional verification (by the verification module 20) between the T-spec datapath and the synthesized pipeline implementation natural to do. T-spec can elevate design abstraction by allowing a designer to reason about a system at the transaction level, where state transformations happen in a single step. This relieves the burden of a digital circuit designer from having to resolve subtle corner cases associated with the concurrent overlapped execution caused by pipelining.

Starting from a datapath specified in T-spec and the desired pipeline stage boundaries 24, automated analysis can be done by T-piper 18 to gather information about data hazards that can be used in pipeline synthesis and verification. In various embodiments, the analysis generates a list of hazard resolution opportunities 25, which describes all hazard resolution opportunities (e.g., forwarding, speculation) and the suggested resolution strategy according to some predefined schemes. The list of hazard resolution opportunities 25 may be a data file, such as a text file, a html file, or any other suitable file type. The list 25 may also be displayed graphically on a monitor of the computer system 10 and/or stored to a database or file. In response to the hazard resolution opportunities output 25, the user can specify in the hazard resolution input 26 how each identified hazard is to be resolved (explained further below). The user may, for example, a default resolution scheme, a recommended resolution scheme, or the user could manually modify the hazard resolution configuration to target a particular resolution strategy of interest. After the data hazard analysis, automatic pipeline synthesis can then generate the desired pipelined implementation 28. Unlike previous works, the proposed approach can pipeline any arbitrary datapath, automatically identify and place forwarding paths, and support general value speculation.

Alongside synthesis, a verification file 30 can be automatically generated by the verification module 20. The file may contain verification models of the T-spec 22 and the synthesized pipeline 28, along with the appropriate abstractions and proof decompositions. The file 30 can be submitted to a compositional model checker to formally verify that the synthesized pipeline is functionally equivalent to its T-spec, under the transactional execution semantics. Unlike existing works on simulation-based validation, the proposed approach may employ a formal technique, and therefore can cover the entire design space. Relative to other formal techniques, compositional model checking is more scalable, since it allows dividing the verification problem into smaller sub-problems that are individually manageable to handle.

Many pipelined design developments begin with creating an initial non-pipelined (so-called “single-cycle”) reference implementation where each system state is instantiated explicitly and, in each clock cycle, a set of combinational logic operations computes the next-state based on the current state. For example, in a prototypical RISC processor development, the instruction-set architectural states are instantiated in the single-cycle implementation, where they are transformed according to the execution of one instruction per cycle. Starting from this reference design point, the pipelining transformation begins with first establishing the desired pipeline stage boundaries, dividing the next-state logic datapath into multiple segments as pipeline stages. To support overlapped execution of multiple operations, hazard detection and stall logic is introduced to maintain the correctness of the operations in the overlapped executions. As necessary, forwarding and/or speculation are added to minimize performance loss due to stalls. The basic methodology for pipelining is well established but nevertheless tedious and error-prone if applied manually and haphazardly.

A single-cycle version is much simpler to specify and implement correctly than the final pipelined version. The single-cycle version also serves very effectively as a functional specification of the final pipelined design, as well as a reference model utilized in many verification techniques. In fact, during design exploration, a single functional specification may be transformed into multiple pipeline implementations. Thus, it is useful to distinguish, respectively, the “what” from the “how” of pipeline designs. The simplicity of the single-cycle version is that the designer is only concerned with next-state computation that happens in a single step, avoiding the need to reason with the interactions between multiple concurrent overlapping operations. In various embodiments, the T-spec 22 adopts and expands on this basic thinking on datapath specification.

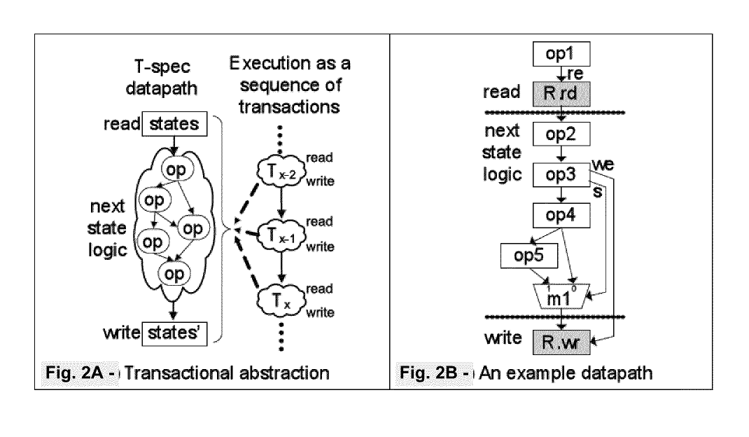

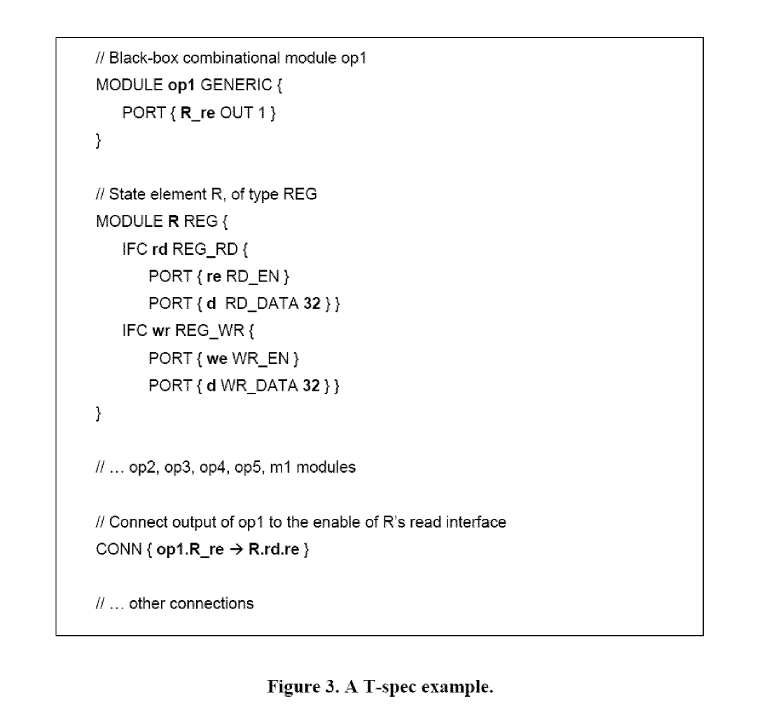

FIG. 2a illustrates a transaction abstraction. Similar to a single-cycle design, T-spec can be conceptualized as a textual “netlist” that comprises state elements and next-state compute operations implemented by a network of logic blocks. However, unlike a single-cycle implementation, a T-spec's execution semantics may be interpreted as a sequence of “transactions,” where each transaction reads the state values left by the preceding transaction and computes a new set of state values to be seen by the next transaction. Both single-cycle and T-spec datapaths perform state transformations in a single step, but a T-spec datapath execution is sequenced by transactions, instead of clock cycles. As a result, T-spec decouples the datapath specification from a particular implementation. For example, a transaction may be mapped to an implementation that takes multiple clock cycles. According to various embodiments of the present invention, however, it is possible to synthesize an in-order pipelined implementation that executes multiple overlapped transactions, yet maintains the transactional semantics of the datapath described in T-spec. In general, any implementation may be derived from a T-spec, as long as it preserves the transactional semantics.

In practice, T-spec may retain the same type of information as that captured by a RTL (register transfer level) description of a datapath, which consists of state elements and next-state logic blocks. However, T-spec preferably adds to a typical RTL description several interface and type requirements, which are useful in capturing the state access behaviors of the transactions that can be executed by the datapath. Such information is beneficial in reasoning with data hazards that could happen in a pipelined implementation to be derived from the T-spec in a precise manner Details on the data hazard analysis are provided further below. First, an elaboration on the information captured by a T-spec is provided.

In various embodiments, without loss of generality, the T-spec netlist only includes register-type state elements of arbitrary word-size, and array-type state elements of arbitrary size. FIG. 2b provides the schematic netlist of an example design. This design comprises of a single state element R (e.g., a register) and a network of logic blocks (op1, op2, op3, op4, op5, and m1) (“m” representing a multiplexer), with the register-type state element R represented by its separate read interface and write interface. In a valid T-spec, a particular register or array location can be written at most once by a transaction. The effect of a write is only observable starting with the next transaction.

Preferably, a state-read interface in T-spec includes an explicit “read enable” control signal. This read-enable preferably is not a tristate control; rather it is preferably purely a bookkeeping signal to help T-piper refine read-after-write (RAW) hazard analysis by letting the designer indicate exactly when a transaction must see the valid value of a state element in order to proceed. Similarly, an explicit “write-enable” is included in a state-write interface.

An acyclic network of combinational logic blocks computes the next-state update for the write-interfaces of the state elements based on the current state values received from the read-interfaces of the state elements. Only the input and output ports of the combinational logic blocks are declared in a T-spec according to various embodiments. Except for multiplexers, T-piper 18 may treat all combinational logic blocks as black-boxes during analysis. In various embodiments, multiplexer is a built-in logic primitive understood by T-piper 18 and used for hazard analysis.

Besides combinational blocks, a T-spec netlist can also include next-state logic blocks with asynchronous interfaces. Beside data inputs and outputs, these blocks preferably also support an established set of handshaking signals, such as: ready, start, and done. The ready output signal indicates when an asynchronous block is ready to accept a new set of data inputs. A new calculation is performed by asserting the start input signal until the data output is valid, as indicated by the done output signal. Each asynchronous block can be executed at most once by each transaction. Asserting start implicitly resets any internal state so no history can be carried from one transaction to the next. In the final synthesized clock-synchronous pipeline, an asynchronous block in T-spec may be replaced by a corresponding library block that produces its output after a fixed or variable multi-cycle delay (e.g., an iterative divider). T-spec may also support state elements with asynchronous interfaces whose read and write interfaces are not always available immediately. This may be used to represent hardware structures such as a memory element that contains a cache, where access latency varies depending on whether there is a cache hit or not.

Preferably, an external input to a T-spec datapath is associated with the read-interface of a special Input-type element. The usage of the Input read-interface is similar to that of a register-type element, except the value read from an Input element's read-interface is not associated to any prior state update operation. The value returned from reading an Input read-interface reflects directly the external environment that the input is combinationally connected to. In various embodiments, an Input read-interface is not subjected to RAW hazard analysis during synthesis. Similarly, an external output may be associated with the write-interface of a special Output-type element that is connected to the external environment. The usage of the Output write-interface is similar a register-type element. Functioning like a register, the external output will hold the last written value until the next write. The Output write interface is also not subjected to RAW hazard analysis in various embodiments.

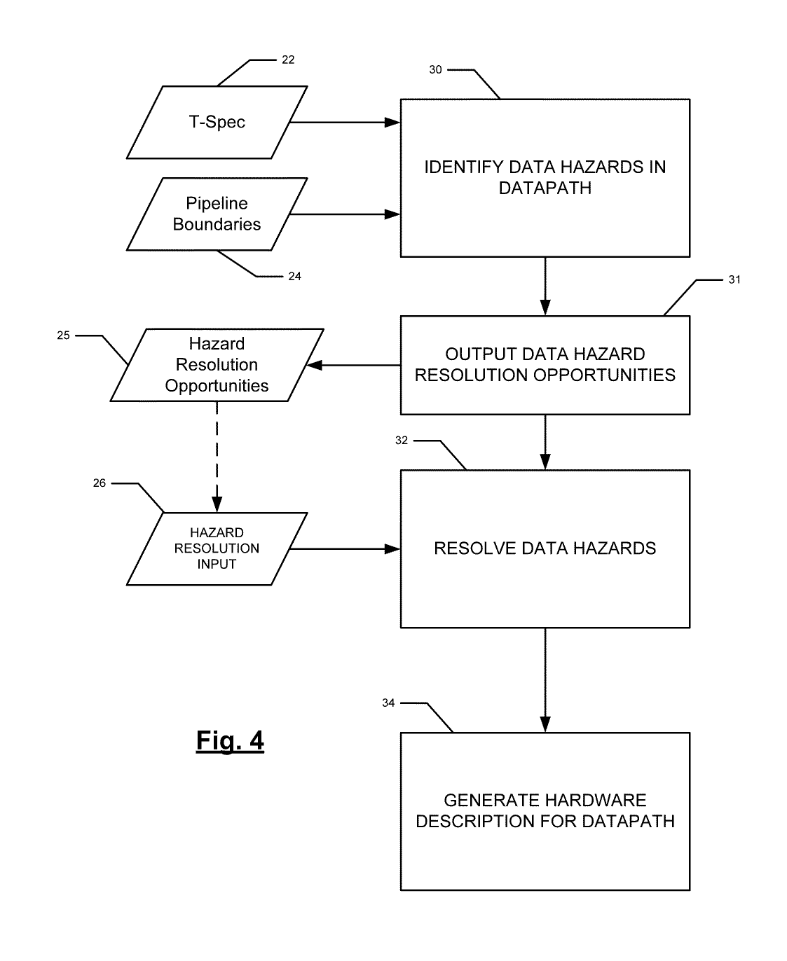

FIG. 3 depicts a T-spec excerpt for the datapath example in FIG. 2b. The T-spec begins with a GENERIC module declaration for op1, a black-box combinational block. It has a 1-bit output named R_re. (This input-less block represents a hardwired constant.) The second module declaration is for a built-in REG-type state module named R. A REG-type state module has explicit read and write interfaces (i.e., named rd and wr in this case). The read (or write) interface comprises of a read-enable (or write-enable) port and an output read-data (or input write-data) port. The declared data-width of R is 32-bit. Lastly, a connection declaration connects the R_re output port of op1 to the en input port of R's rd interface. The declarations for the remaining modules and connections are omitted for brevity. Appendix A hereto provides the complete T-spec language syntax according to various embodiments, and Appendix C provides an example T-spec for a MIPS processor datapath.

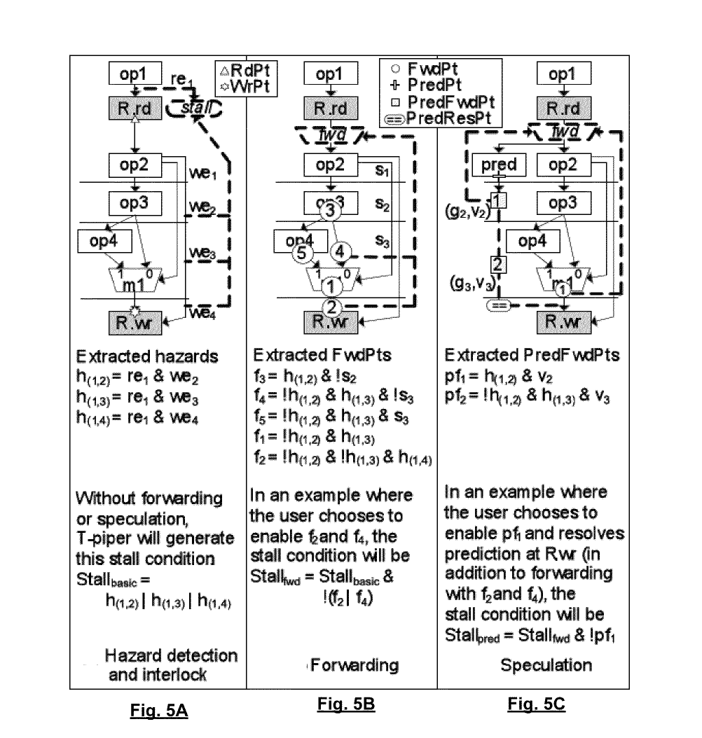

FIG. 4 is a flow chart of a process of the T-piper module 18 according to various embodiments of the present invention. The computer 12 may perform the process of FIG. 4 when executing the code of the T-piper module 18 in order to generate the hardware description for the pipeline datapath, such as a RTL Verilog implementation of the desired pipeline datapath, which preserves the transactional semantics of the T-spec datapath. The illustrated process starts at step 30, where the T-piper module 18 identifies data hazards in the datapath to be synthesized based on at least (1) the T-spec 22 for the datapath and (2) the pipeline boundaries 24. The data hazards that the T-piper module 18 identifies can include so-called read-after-write (RAW) data hazards and/or write-after-write (WAW) data hazards, or any other applicable data hazard type. At step 31, the T-piper module 18 may output the hazard resolution opportunities 25 for the hazards identified at step 30. In response to the hazard resolution opportunities 25, the user/designer can input how the identified hazards are to be resolved 26. Next, at step 32 the T-piper module 18 resolves the data hazards identified at step 30 based on, at least in part, the hazard resolution input 26. With the identified data hazards resolved, the hardware description for the datapath is generated at step 34. The hardware description may comprise, for example, a RTL implementation, such as Verilog RTL implementation or some other suitable RTL implementation. Also, the hardware description may comprise a schematic for the datapath that can be converted to a RTL implementation, for example. More details about the steps in the process of FIG. 4 are described further below.

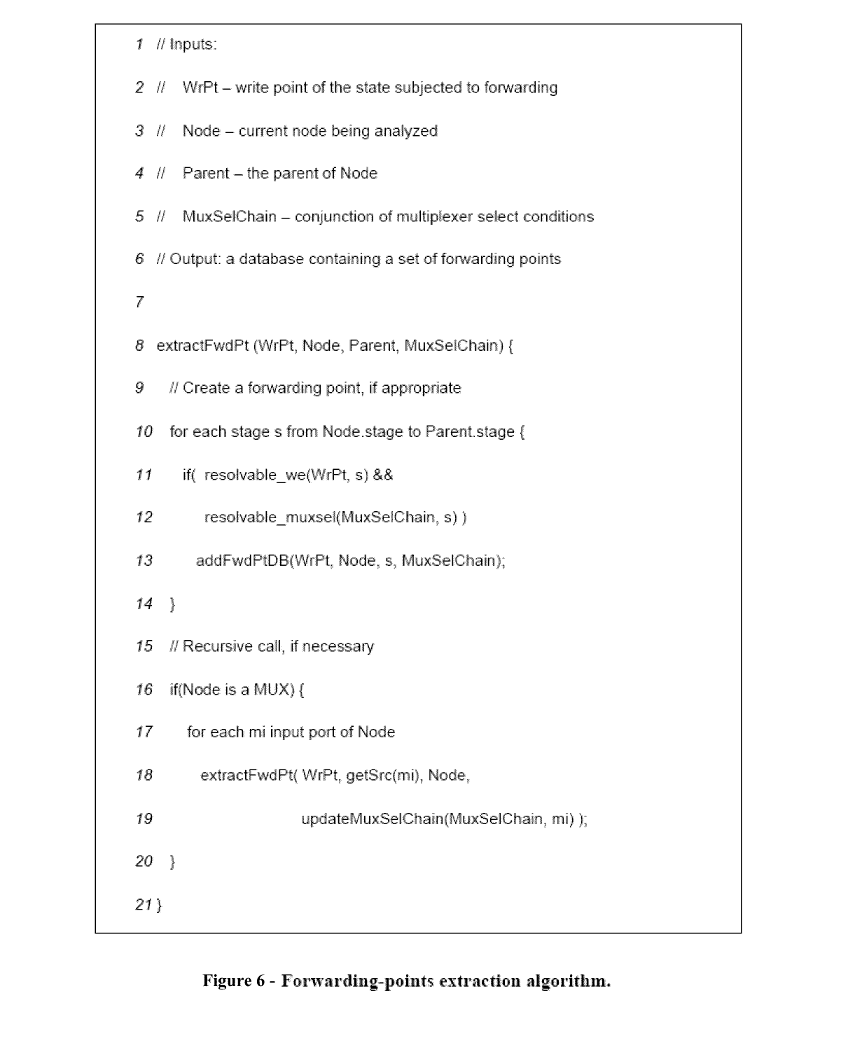

In various embodiments, the desired pipeline stage boundaries in the datapath are expressed by declaring the number of stages and assigning each module (or interface in the case of a state element) in the datapath to a pipeline stage. As an example, FIGS. 5A-C depicts a possible set of pipeline stage boundaries (shown in solid lines) for the T-spec datapath in FIG. 2(b), where the op1, op2 and R.rd modules are assigned to stage 1; op3 is assigned to stage 2; op4 and multiplexer are assigned to stage 3; and R.wr is assigned to stage 4.

In various embodiments, the following boundaries constraints are used. When assigning modules to stages, the destination module of a connection cannot be assigned to a stage earlier than the source module. The write interface of a state element also cannot be assigned to a stage earlier than the state element's read interface. If an array state element supports multiple write interfaces, the write interfaces must be assigned to the same stage. These constraints on state read and write interface assignments exclude the possibility of write-after-write and write-after-read data hazards.

Given a datapath in T-spec 22 and pipeline-stage assignments 24, the T-piper module 18 analyzes the input design at step 30 of the process of FIG. 4 for, for example, RAW hazards when transactions are executed in a pipelined fashion. The T-spec datapath 22 from FIG. 2(b) is divided into four stages in FIGS. 5A-C. As such, multiple versions of a signal (corresponding to different transactions in different stages) co-exist if the source and destination of a connection are not located at the same pipeline stage. For example in FIG. 5A, the we signal traverses all four stages since its source (op2) is located in the first stage, while its destination (R.wr) is located at the fourth stage. When op2 is computing we₁ for transaction T₁ in stage 1, we₂ is an older version of the same signal belonging to the older transaction T₂ in stage 2. Similarly, we₃ and we₄ belong to transactions T₃ and T₄, respectively.

For hazard analysis, in various embodiments, the T-piper module 18 identifies for each state element a “read-point” (RdPt) associated with the state element's read interface. In FIG. 5A, the read-point for the state element R is labeled with a “triangle”-symbol. A read-point is qualified by its state element's explicit read-enable; that is, a read-point is required to carry a valid state value only when its accompanying read-enable is asserted. Similarly, a “write-point” (WrPt) is associated with the write-data interface of the state element, and is qualified by the write enable.

In FIG. 5A, the write-point for the state element R is labeled with a “star”-symbol. A write-point carries the new state update value only if its write-enable is asserted. In general, with respect to any state element E in a datapath, a hazard condition exists whenever there are two “in-flight” transactions in the pipeline, and the younger transaction is reading from E while the older transaction is planning to write to E. In other words, a data hazard occurs when there is a younger transaction Tₓ and an older transaction Tₓ₊ᵢ that occupy stage x where E's read-point resides and a later stage x+i between the read-point and the write-point of E, respectively. Furthermore, Tₓ asserts the read enable of E, and Tₓ₊ᵢ asserts its write enable (i.e., reₓ and weₓ₊ᵢ is true (Boolean logic)).

When a data hazard occurs, Tₓ will receive an incorrect state value if it reads from E directly because the update value by Tₓ₊ᵢ has not yet been written to E. Thus, Tₓ must stall (i.e., delay the reading of E) if (reₓ & weₓ₊ᵢ) is true for any stage between the read-point and the write-point of E. The expression for Stall_{basic} in FIG. 5A is constructed accordingly to indicate when the reading of the state element R in the example must be stalled.

When stalling the transaction Tₓ, the older transactions downstream in the pipeline must be allowed to proceed so Tₓ₊ᵢ will eventually progress past the write-point of E, removing the hazard condition. It is possible for weₓ₊ᵢ to not exist if we is computed by a module assigned to a later stage. For the purpose of hazard analysis, weₓ₊ᵢ must be assumed true whenever the stage x+i is occupied by a transaction. For example, in FIG. 5A, if we were computed instead by op4 in stage 3, then we₁ and we₂ do not exist, and it can be conservatively assumed that the transactions in stages 1 and 2 will assert their we.

If the state element E is an array, the T-piper module 18 may carry out hazard analysis at the granularity of individual locations. Given rd-idx and we-idx are the indices to the read and write interfaces of E, a hazard condition arises only if (reₓ & weₓ₊ᵢ) and (rd-idxₓ==wr-idxₓ₊ᵢ) are true. In other words, the read and write of the array element E by Tₓ and Tₓ₊ᵢ only conflict if they are to the same location in E.

The aforesaid hazard analysis may be repeated independently for each state element in the datapath. The stalling logic generated by the hazard analysis procedure may be used in conjunction with an implementation-specific method that tracks the existence of valid transactions in pipeline stages. For this work, when synthesizing an implementation from a T-spec 22, a valid bit is added to each stage for this purpose. The bit may be set and cleared accordingly as transactions enter and leave the pipeline.

Based on the simple analysis in the previous section, the T-piper module 18 can already emit a correct pipelined implementation. The pipeline's effectiveness depends on how often the tall conditions are triggered at runtime. In some cases, a stall can be avoided if the required not-yet-committed state update values from an older transaction still in flight can be forwarded (bypassing the state element) to the younger dependent transaction. In some cases, a stall can be avoided if the required not-yet-committed state update values from an older transaction still in flight can be forwarded (bypassing the state element) to the younger dependent transaction.

To determine forwarding opportunities, the T-piper module 18 may further identify a set of “forwarding-points” (FwdPt) for each state element. Starting from each write-point, T-piper module 18 may trace the write-data signal backwards across pipeline boundaries to find all points (output of a module or a pipeline-stage register) where the write-data signal and its accompanying write-enable signal are both available. When the associated write-enable is asserted, the value at a forwarding-point can be provided to the read-point for use by a dependent younger transaction in lieu of stalling.

To ensure a valid forwarding, one must also preferably ascertain that no other transactions between the read-point and the forwarding-point also want to write to the state element (according to the transactional semantics, when multiple older transactions have outstanding writes to a state, the current reader of that state depends on the youngest of those transactions). Forwarding-points can be traced backwards through a multiplexer to create conditional forwarding further qualified by the mux-select logic.

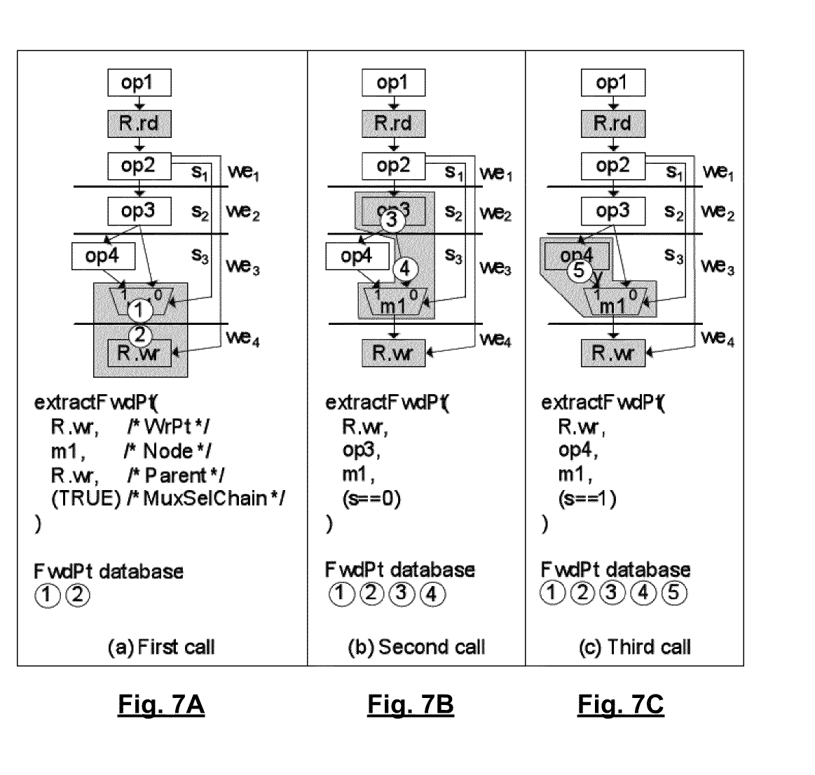

FIG. 6 provides the pseudo-code for the forwarding-points extraction algorithm according to various embodiments. The network of operations in T-spec 22 may be treated as a Directed Acyclic Graph (DAG) with a state write-point at the root of the graph. The direction of the edges in the DAG is opposite of the dataflow. The algorithm performs a depth first traversal from the root of the DAG, visiting each node where forwarding may happen.

The algorithm may comprise two parts in various embodiments. The first part (i.e., the first for-loop) analyzes the pipeline stages between the node under analysis and its parent, and creates forwarding-points accordingly. The analysis involves checking whether the predicate of a potential forwarding-point is resolvable or not. In line 11, resolvable_we(WrPt, s) checks if the write enable signal for WrPt is available in all stages between s and the state's read-point. Dynamically, forwarding is only valid if the write enable in stages earlier than s are all de-asserted (i.e., no writes by any transaction younger than the one in stage s). In line 12, resolvable_muxsel(MuxSelChain, s) checks if all of the mux-select conditions in MuxSelChain have been computed by stage s. If all the required predicates for forwarding are resolved, then the forwarding-point is inserted to a list (by addFwdPtDB( ) in line 13).

The second part of the algorithm deals with the case when the node is a multiplexer. Because a multiplexer only passes data value, each of the input paths may be recursively analyzed for additional forwarding-points. However, each forwarding-point on the input path has to be further qualified by the mux-select signal. In line 18, a recursive call is made for each of the multiplexer input paths. For each input path, updateMuxSelChain( ) in line 19 adds the required select signal for the current multiplexer to the conjunction of the select conditions for the previously visited multiplexers between the current node and the root.

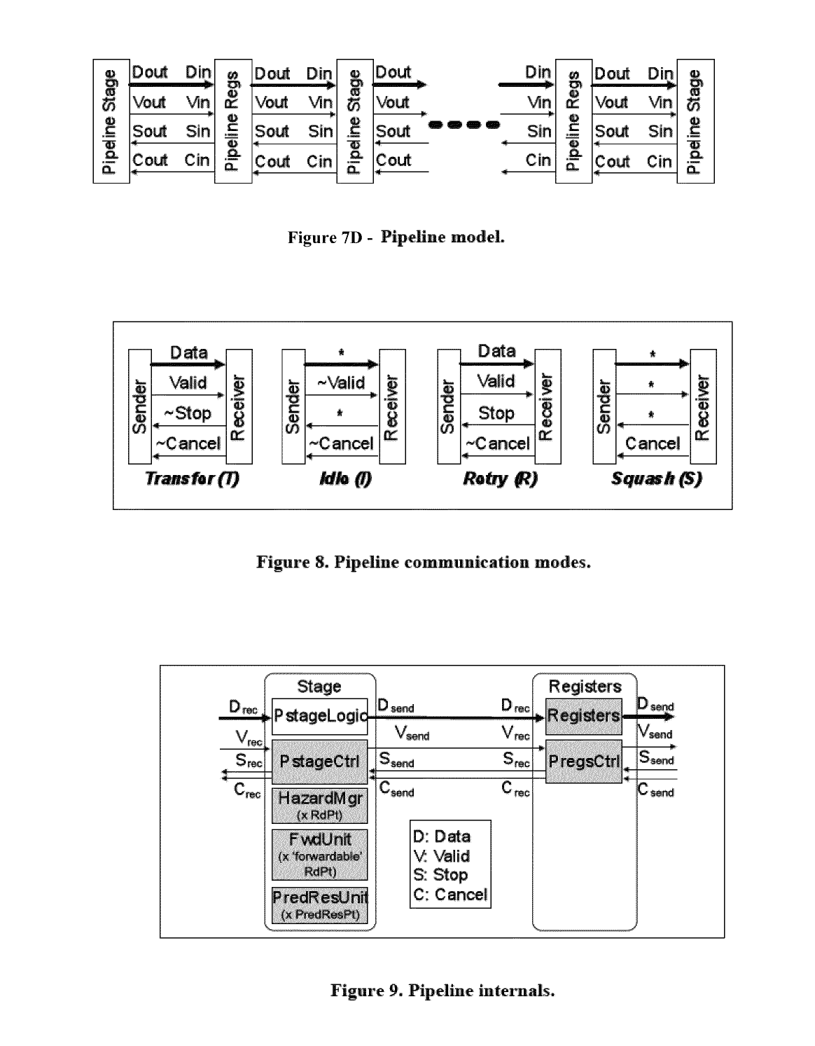

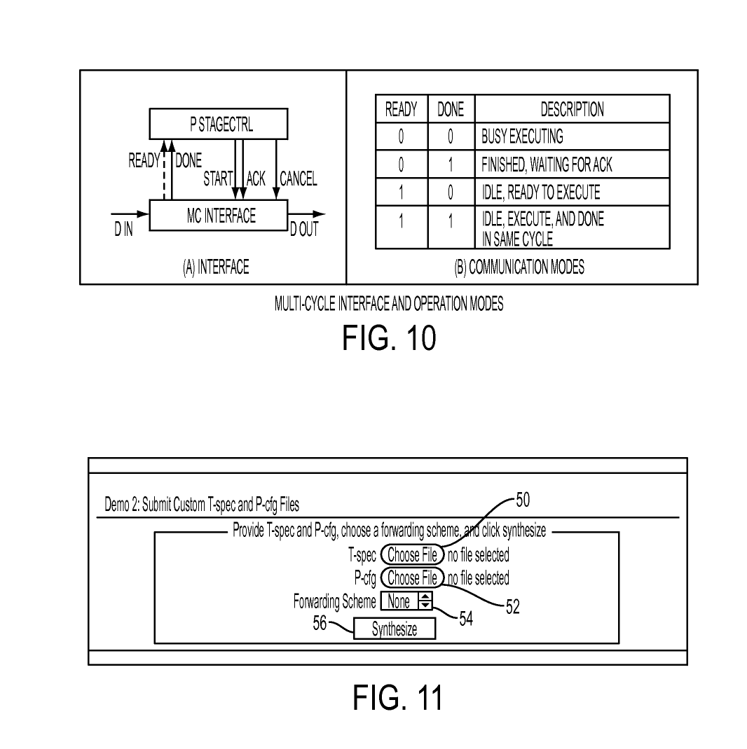

FIGS. 7A-C illustrate an application of the algorithm to the datapath example in FIG. 5A. FIG. 7A depicts the first call to extractFwdPt( ) Since this is the first call, Node is the input source to the root of the DAG (R.wr), which is m1. Parent is R.wr itself. Since no multiplexer is encountered yet, MuxSelChain is initially TRUE. The shaded area indicates the part of the DAG under analysis (i.e., between R.wr and m1). The first part of the algorithm analyzes the stages between m1 and its parent, R.wr. Since all the write enable signals (we₁, we₂, we₃, and we₄) between R.rd and R.wr are available, resolvable_we( ) returns TRUE for stages 3 and 4. Two forwarding-points (i.e., the “circle”-symbols labeled with 1 and 2) are added to the forwarding-points database. Next, since Node is a multiplexer, the second part of the algorithm invokes the recursive calls to each of the two inputs of m1.

FIG. 7B shows the second (recursive) call to extractFwdPt( ) on input 0 of m1. The shaded area indicates the part of the DAG being analyzed. Node is now op3, which is the source of input 0 of m1 (obtained by getSrc( ) in the first call). Parent of op3 is m1. Since the algorithm traversed through input 0 of multiplexer m1 to get to this call, the condition (s==0) is added to MuxSelChain. The first part of the algorithm analyzes stages 2 and 3 (i.e., where Node op3 and Parent m1 belongs to, respectively) resolvable_we( ) and resolvable_muxsel( ) return TRUE for stages 2 and 3, since the required predicates are available (i.e., {s₂, we₂, w₁} and {s₃, we₃, we₂, we₁} respectively). Two forwarding-points (3 and 4) are inserted to the forwarding-points database. Similarly, FIG. 7C depicts the third call to extractFwdPt( ), or the second recursive call at m1 for input 1. For the datapath in FIGS. 7A-C, the depth-first traversal ends at the children of m1. However, further calls could have happened if there was a chain of multiplexers in the datapath (e.g., if an input to m1 was a multiplexer).

The five forwarding-points of R in FIG. 5B are labeled by numbered “circle”-symbols. The numbers correspond to the traversal order by the algorithm in FIG. 5B. For each forwarding-point, FIG. 5B gives the exact condition when the value at a forwarding-point can be used by the transaction at the read-point stage in lieu of stalling. For example, forwarding-point 2 is valid iff (if-and-only-if) T₁ depends on T₄ with respect to R but not on T₃ or T₂. Likewise, forwarding-point 1 is valid iff T₁ depends on T₃ with respect to R but not on T₂. Points 5 and 4 are conditional forwarding-points corresponding to the two possible settings of m1's the mux-select (sᵢ). The condition for using forwarding-point 5 (or 4) is the same as 1 with the additional requirement that the multiplexer m1 in question is set to select the 1-path (or the 0-path). Forwarding-point 3 is an earlier version of forwarding-point 4, allowing forwarding from T₂ to T₁ when s₂ is not asserted.

In various embodiments, after the data hazard analysis at step 30, the T-piper module may report to the user, in the hazard opportunities output 25, all forwarding-points. Based on the user's selection of which to include (e.g., the hazard resolution input 26), the T-piper module 18 may generate a pipelined implementation with the selected forwarding paths. When a forwarding path is added, its exact trigger condition is subtracted from the stall condition. When the trigger condition is satisfied, the would-be RAW hazard is resolved by forwarding from the corresponding forwarding-point. The example in FIG. 5B adds forwarding from forwarding-points 2 and 4, resulting in a new stall condition Stall_{fwd} that subtracts f2 and f4 from Stall_{basic}.

It is important to note an injudicious selection of forwarding-points does not always help performance and could even hurt performance by creating unwanted long critical paths. For example, adding forwarding-point 1 in FIG. 5B would create a critical path spanning two-stages worth of combinational logic (op4 and m1 in stage 3, and op2 in stage 1). In addition, a forwarding path does not improve performance unless it is triggered frequently during execution.

Forwarding can only be done if an older transaction already computes (but has not yet written) the value that a younger transaction depends on. Consider the example in FIG. 5B. If a younger transaction in stage 1 depends on the value of R to be produced by an older transaction currently in stage 2 via op4 eventually (i.e., mux select is 1), then the younger transaction has to wait for 1 cycle for the older transaction to reach stage 3 and utilizes op4 to compute the value, which can then be forwarded using either forwarding-point 1 or forwarding-point 5.

In cases where forwarding cannot sufficiently reduce the RAW hazard stalls, T-spec 22 can support a general-purpose framework for a designer to introduce a value predictor to resolve RAW hazards speculatively. Starting with a T-spec datapath with complete functionality, a designer can introduce auxiliary state elements and logic blocks for value prediction. In parallel to the original full determination of the next-state value of a given state element E, the auxiliary states and logic blocks are to compute, presumably faster and with less logic effort, a “guess” for the next-state value of E. With each guess, the auxiliary logic also generates a Boolean valid signal to indicate whether the guess should be used for speculation. This valid signal should only be asserted when the confidence in a guess is high; otherwise stalling is preferred over speculation to avoid the misprediction recovery penalty.

The auxiliary states and logic blocks for making value predictions can be specified using the same T-spec syntax and constructs as the original primary state and logic. In various embodiments, they are allowed to depend on the value and output of the primary states and logic blocks, but not vice versa. In other words, the T-spec 22 of the primary datapath should preferably stay exactly the same whether or not value prediction is added. In FIG. 5C, the auxiliary logic module pred is making a guess for the next-state value of register R in stage 1 whereas the true next-state value of R is not fully resolved until stage 3 (at the m1 output). In this example, a guess is generated combinationally based on the primary state elements only. In general, one could introduce and maintain new auxiliary state elements and logic blocks to describe arbitrarily elaborate history-based value predictors for any of the state updates.

For each predictor in T-spec 22 that guesses the next-state value of a state element E, the T-piper module 18 may automatically generate a pipelined implementation that incorporates the predicted value (when the associated valid bit is asserted) in speculative executions. A prediction-point (PredPt in FIG. 5C) is the output of a value predictor (g), and is qualified by its valid signal (v) generated also by the predictor. The value of a valid prediction-point can be forwarded to the read-point at a “prediction-forwarding-point” (PredFwdPt) in the same way as a forwarding-point. Prediction forwarding can be done in the stages starting from the prediction-point to the corresponding write-point (or until forwarding-points are available). In FIG. 5C, the possible prediction-forwarding-points are labeled by the numbered “box”-symbols. The figure also shows an implementation that makes use of prediction-forwarding-point 1, resulting in a new stall condition Stall_{pred}.

If value prediction is used in a design, the T-piper module 18 may generate automatically the mechanism to track and eventually verify a transaction's predicted next-state value for E against the dutifully calculated true next-state value for E. By default, the check will happen at the write-point of E (as shown in stage 4 of the example in FIG. 5C), incurring minimum resolution logic, but maximum penalty for incorrect prediction. In various embodiments, the user can also instruct the T-piper module 18 to check prediction in advance of the write-point by comparing against user-selected forwarding-points to reduce the misprediction penalty. If the prediction resolution is done behind a multiplexer, then the T-piper module 18 preferably makes sure that the resolution includes the set of forwarding-points that cover all possible paths to the multiplexer (e.g., forwarding-points 4 and 5).

During a prediction check, if the predicted value and the actual value agree, nothing more needs to be done. However, if they disagree, all younger transactions in flight following the mispredicting transaction are preferably squashed from the pipeline. The mispredicting transaction is allowed to complete fully since the transaction itself never made use of the prediction. The execution continues by restarting the next transaction using the now available correct state values. Due to the need to squash and restart, no write-points for any state elements may be assigned to a stage where unchecked value predictions remain. This assignment constraint ensures that flushing the transient contents of just the pipeline registers is sufficient to recover to the restart state, without needing to undo any state changes to the system state elements.

The support for value prediction and speculative execution is particularly important to instruction processor pipelines. In the RISC pipeline discussed below, a straightforward, combinational prediction of PC+4 can be introduced as the next-state value of the program counter (PC) register; a deeper CISC pipeline requires more elaborate history-based prediction. Without PC prediction, it would be impossible to fetch a new instruction each cycle in either the RISC or the CISC pipeline.

A transaction (say, A) that makes an estimate should not use its own estimate in its computation. Therefore, its computation is not affected by the estimate, and A will always produce the correct actual value that can be used to check the correctness of its estimate. The estimate is used only by any transactions following A, as necessary. These transactions are canceled if when A checks for its estimate against the actual value (after A has finished computing it) determines that the estimate was incorrect. (if correct, then do nothing). Examples of useful estimated value would be for write enable signal, multiplexer signal (i.e., control signals). It may be useful to estimate/speculate on other types of value as well.

Once the data hazards in the pipeline are identified, the T-piper module 18 may output the hazard opportunities 25 to the user and resolve the hazards using the appropriate data hazard resolution technique (e.g., forwarding, prediction, etc.) at step 32 (see FIG. 4). The hazard resolution inputs 26 may contain the specification of which value forwarding, prediction forwarding, and prediction resolution points should be implemented from all of the extracted design points. In various embodiments, MAX (enable all), ASAP (enable only earliest points), and ALAP (enable only latest points, which is used for prediction resolution) are provided as default heuristics to automatically generate such a configuration. The designer could select their desired configuration using a web-based user interface, for example. In other embodiments, the designer can also provide a manually written hazard resolution inputs file 28 to be used by the T-piper module 18.

Once the identified data hazards are resolved, the hardware description for the datapath may be generated at step 34 (see FIG. 4) In various embodiments, synthesis of in-order pipelines that follows the model depicted in FIG. 7D may be supported. In this model, a pipeline consists of pipeline stages and register sets, connected via a communication channel based on “Valid”, “Stop”, and “Cancel” signals. The use of “Valid” and “Stop” signals is inspired by the protocols described in J. Cortadella, M. Kishinevsky, and B. Grundmann, “Synthesis of Synchronous Elastic Architectures”, Design Automation Conference, 2006, which is incorporated herein by reference in its entirety. The “Cancel” signal is added to support speculative execution in the pipelines. Note that the choice of pipeline model targeted by this synthesis process is orthogonal to the data hazard analysis. This model was chosen based on Valid and Stop bits in the implementation for its simplicity, although in other embodiments more complex models may be used.

The communication channel among the pipeline stages and register sets works as follow in various embodiments. A Valid signal indicates data validity, and a Stop signal indicates whether a recipient (could be a pipeline stage or register set) has accepted the data. Thus if a sender asserts its Valid signal, and a recipient deasserts its Stop signal, a Transfer would occur. If the sender deasserts its Valid signal, then there is no data to be sent regardless of what the Stop signal condition is, in which case the communication channel would be Idle. If there is a valid data value to be sent, but the recipient is not yet ready to accept it (i.e. Stop is deasserted), then the communication channel status would be Retry, and the sender will persistently assert its Valid signal until a Transfer occur.

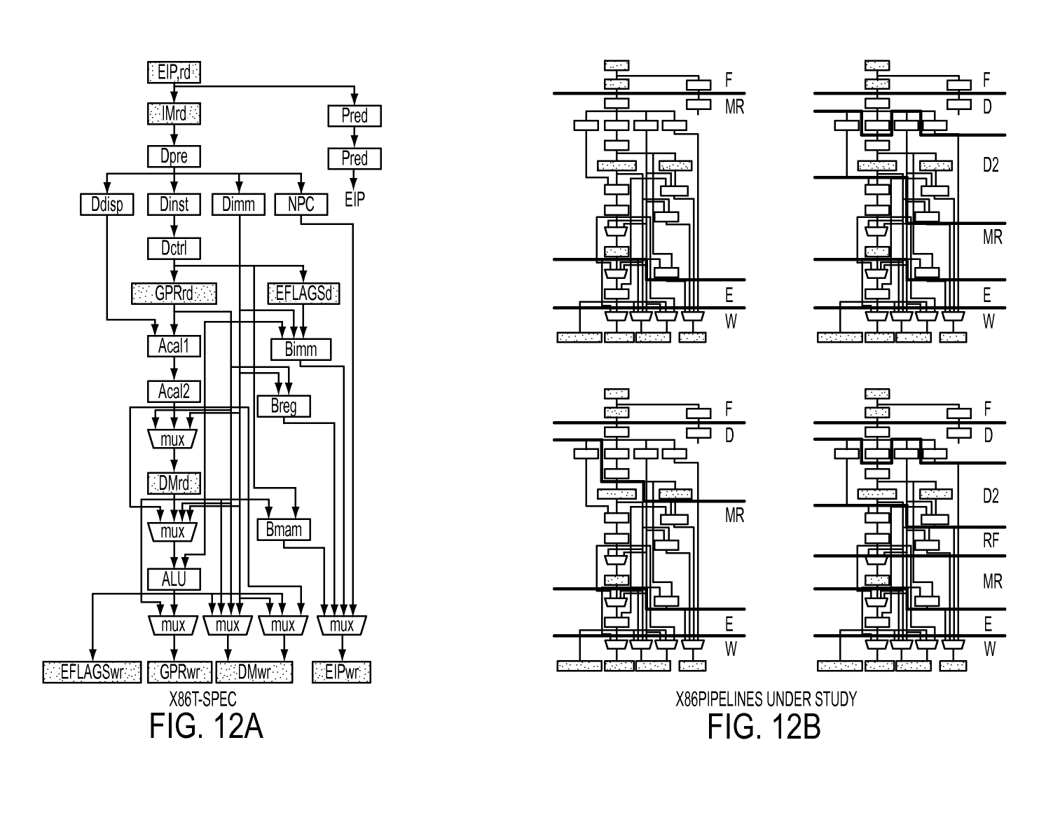

Furthermore, the Cancel signal may be used to qualify a data transfer. Whenever Cancel is asserted, the sender will nullify its operation, and therefore invalidates the data that it is trying to send. An asserted Cancel signal causes a Squash in the data transfer, regardless of the condition of the Valid and Stop signals. If Cancel is de-asserted, then the protocol operates as usual. FIG. 8 shows the aforementioned communication modes.

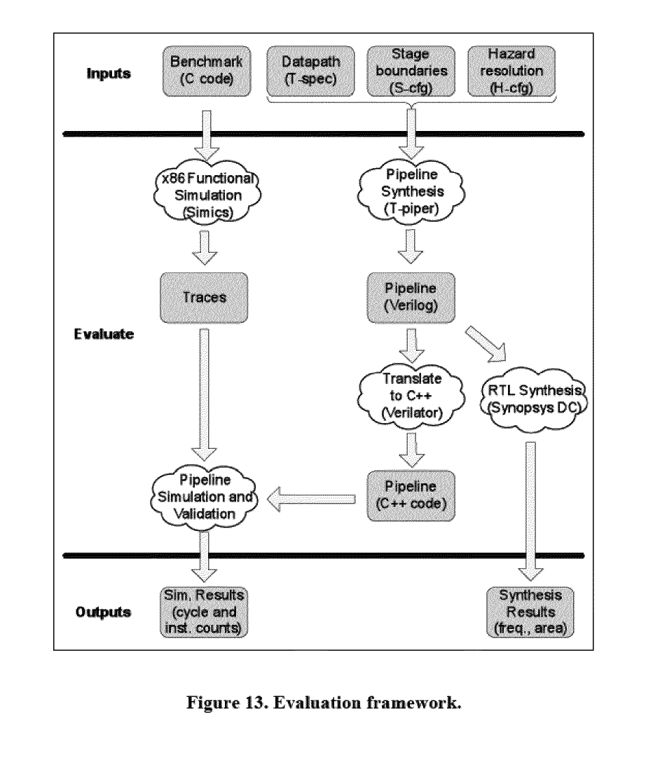

According to various embodiments, the contents of a pipeline stage and a register set are shown in FIG. 9. The pipeline stage logic (PstageLogic) contains the datapath modules and state access interfaces instantiated in T-spec, and are obtained from the component database during T-piper synthesis. The shaded components in the figure are pipeline management logic generated automatically by the T-piper module 18. The pipeline stage controller (PstageCtrl) is responsible for (1) monitoring and generating the hand-shaking signals for communicating with the neighboring pipeline register sets, and (2) interacting with other components (PstageLogic, etc.) in the stage. There is one PstageCtrl per stage. The synthesis of this unit is straightforward. Stop output is synthesized by analyzing stall conditions due to hazards (from HazardMgr) and multi-cycle (MC) interfaces (discussed below). Stop is asserted when the stage stalls. Valid is synthesized by analyzing the interfaces in the stage, and is asserted when the stage has completed execution. Cancel is synthesized by analyzing PredResPts, and it is asserted when later stages encounter any mispeculation (i.e., triggered by a PredResUnit).

The data hazard manager (HazardMgr) may detect the existence of data hazards, and activate the appropriate hazard resolution logic. In various embodiments, since hazards are detected at the system state read-interfaces, one HazardMgr is generated for each read interface in the stage. It is synthesized by analyzing the RdPt, WrPt, and the enabled FwdPt and PredFwdPt. The forward unit (FwdUnit) manages forwarding of both actual and predicted values. It acts as a proxy to a read interface, returning either the actual state value or a forwarded value. One forward unit is generated for each “forwardable” read interface (i.e., a read interface with one or more enabled FwdPt or PredFwdPt). Synthesis of a FwdUnit is done by analyzing RdPts and FwdPts/PredFwdPt. The prediction resolution unit (PredResUnit) contains the logic that compares a predicted value with the actual value, and triggers misspeculation when a mismatch occurs. One PredResUnit is generated for each enabled PredResPt in the stage. Synthesis of this unit is done by analyzing PredResPts.

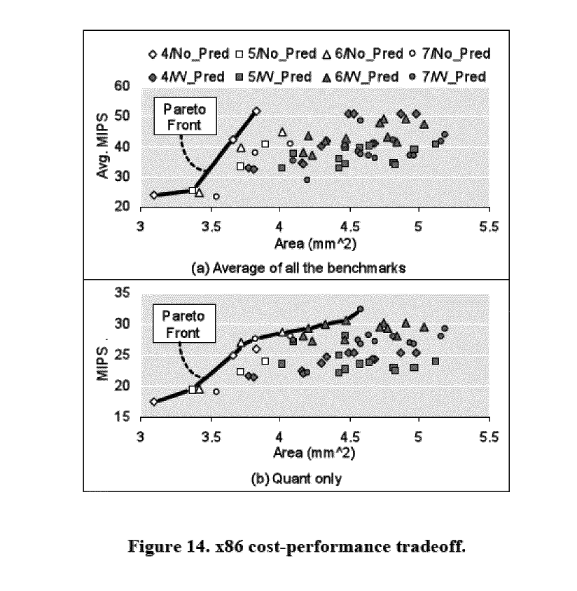

Asynchronous next-state logic blocks may be mapped to multi-cycle (MC) modules with the interface as shown in FIG. 10(a). The interface may contain start, done, ready, ack, and cancel signals. The various communication modes using these signals are shown in the table in FIG. 10(b). When the module first starts up, the ready output signal is asserted, which indicates the MC module is idle and ready for execution. Asserting the start signal can then activate the interface. Once the interface is activated, the MC operation would be performed. The assertion of the done signal would then indicate the completion of the operation. Next, the pipeline control (PstageCtrl) can assert the ack signal when the result of the operation has been consumed. From there, the ready signal of the MC module becomes asserted again. This type of MC interface can also be applied to state read- and write-interfaces to allow the interface to respond with varying delay. This feature is useful, for example, to interface with the cache subsystem of a processor that responds in different number of cycles depending on whether there is a cache hit. Note that the T-piper need not support chaining of MC modules in the same pipeline stage, although in other embodiments such a support can be included.

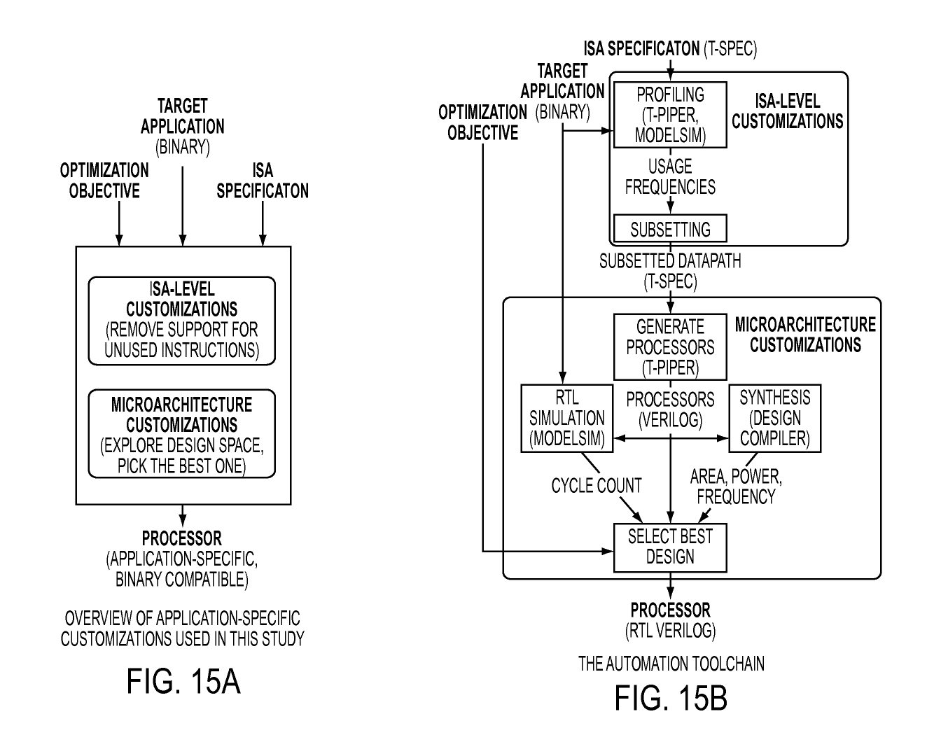

In various embodiments, a web-based user interface may allow the designer to specify the T-spec file 22, the pipeline boundaries (P-cfg) file 24, and the forwarding scheme (e.g., data resolution inputs) 26. FIG. 11 illustrates an example of the user interface. The designer can select a T-spec file 22 at field 50, select a pipeline boundaries (P-cfg) file 24 at field 52, and select the forwarding scheme (e.g., data resolution inputs) 26 at drop-down window 54. By clicking on the “synthesize” button 56, the T-piper module 18 will synthesize the target pipeline implementation as described above. An example of language syntax for the pipeline boundaries (P-cfg) file 24 is provided at Appendix B.

As a study, the inventors trained an undergraduate student to develop a 5-stage MIPS pipeline using T-spec and T-piper. The student has prior experience in developing a textbook 5-stage MIPS pipeline by hand. Including training, the T-spec was completed in under a week. The synthesized pipeline utilized the same datapath components as the handmade pipeline the student had developed previously. Both pipelines support the same set of user-level MIPS instructions (e.g., ALU, memory, and branches). Thus, the difference between the two pipelines is only in the pipeline control logic, one of which is synthesized by T-piper and the other manually developed by the student. It was found that the synthesized pipeline is within 2% in performance and area of the student's hand-made design. Furthermore, the student was also able to synthesize 3, 4, and 6-stage pipelines from the same T-spec by slightly modifying the pipeline stage configuration file (P-cfg) 24.

The inventors also compared the processor pipeline used in the previous paragraph against the open-sourced design of the SPREE MIPS-I processor that is also a 5-stage pipeline with a full operand-forwarding network. See P. Yiannacouras, J. G. Steffan, and J. Rose, “Exploration and Customization of FPGA-Based Soft Processors”, IEEE Transactions on Computer Aided Design of Integrated Circuits and Systems, Vol. 26, No. 2, 2007 (“Yiannacouras”). The inventors found that the MIPS implementation using T-piper could reach an 8% higher clock frequency than the SPREE implementation. The MIPS implementation using T-piper is, however, 4% larger in area then the SPREE implementation at SPREE's peak frequency. This comparison is inexact but should be sufficient to establish that MIPS processor pipeline synthesized using T-piper is a reasonable quality. Moreover, in Yiannacouras, the quality of the SPREE MIPS-I implementation was successfully vetted against the commercial Altera NIOS RISC processor pipeline.

In another study conducted by the inventors, a graduate student who is already familiar with T-spec and T-piper designed a complete user-level MIPS I processor from scratch. Within 5 days, he was able to synthesize MIPS pipelines that supported all of the user-level MIPS I instructions except for the platform-dependent co-processor instructions. In addition to basic RISC instructions, the MIPS I instructions include many variations of memory instructions (e.g., partial and unaligned load and stores), control instructions (e.g., branch and link), and integer multiply/divide (implemented using multi-cycle iterative divider/multiplier functional units) along with HI/LO register move instructions. The breakdown of the development time is as follows:
1) One day was spent reading the MIPS ISA manual and designing the non-pipelined datapath (e.g., the types of components, and how they are connected).
2) One day was spent to describe the datapath in T-spec, and to develop the target pipeline configurations (i.e., P-cfg files). This one day also includes the time spent ironing out bugs to make sure that the T-spec and the P-cfg files are well-formed.
3) Three days were spent for the rest of the development activities, which consists of implementing the datapath components in Verilog, creating the testbench, writing MIPS assembly test programs for validating correct functionalities of supported instructions, and debugging.
   Notice by using T-piper to relieve the designer from the manual pipelining effort, the development time becomes dominated by supporting tasks not directly related to pipeline implementation (e.g., reading manuals, making test cases, etc).

In another study, the inventors created the T-spec for an x86-based processor, and used T-piper to rapidly explore sixty (60) different synthesized pipelines. The inventors evaluated the impact of the various pipeline features and characterized their performance-area tradeoffs. To the best of the inventors' knowledge, their automatic pipeline synthesis approach is the first to be demonstrated with an ISA as complicated as the x86.

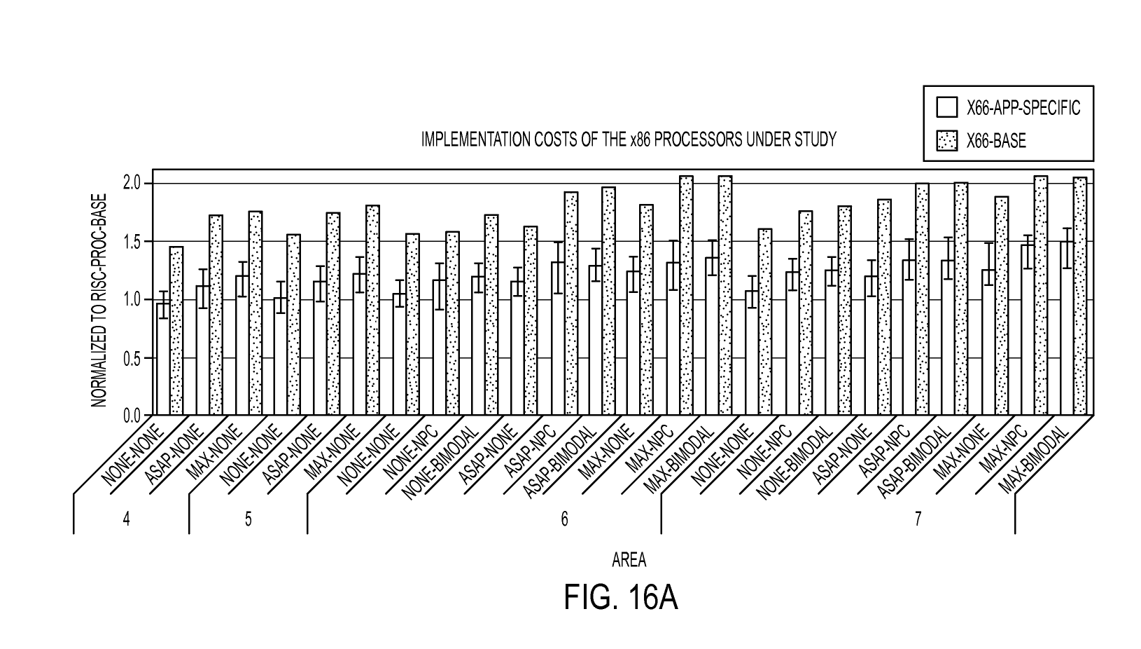

FIG. 12 show the T-spec of the x86 processor and the pipelines under study, respectively. For brevity, several less important details of the datapath are omitted from the figures. For example, only one out of multiple GPR read interfaces is shown. The T-spec design supports all protected-mode general-purpose instructions that do not modify privilege states, except for ASCI/decimal adjustments (e.g., AAA, DAA), bit operations (e.g., bit scan, bit test), divide, swap (e.g., BSWAP, CMPXCHG), string, and I/O (e.g., IN, OUT) instructions. Interrupt and exception handling were also not included. The supported subset of x86 ISA is sufficient to execute the SPREE benchmarks used in the study. The datapath includes a multi-cycle integer multiplier unit and variable-cycle memory interfaces capable of interfacing with memory systems with caches. For the evaluations in this study, however, the inventors assumed a memory system with a perfect cache (no misses) so the focus can be on the effect of various pipeline features on performance.

The inventors explored several manually chosen pipeline parameters in this study. While reasonably complete, these parameters do not span the complete design space. It is possible in future work to develop orthogonally an automatic design space exploration system to replace the manual effort in selecting the pipeline parameters. Below is described the major dimensions of the pipeline configuration parameters considered.

For a baseline, the inventors started with the shortest possible pipeline (i.e., 4-stage, where each multi-cycle interface is assigned to its own pipeline stage) without any forwarding or prediction. The inventors then manually analyzed the critical path and added new pipeline stages to break the critical path and to improve frequency. The inventors continued adding more pipeline stages, up to the point when adding an additional pipeline stage resulted in only a negligible improvement in frequency. The inventors ended up with a collection of pipelines between 4 and 7 stages.

Note that there are many possible pipeline boundaries for a given number of pipeline stages. For example, for a 5-stage pipeline, one could put all the decode units in stage 2, or spread it across stage 2 and 3. If the decode unit that decides whether an instruction is a branch or not is placed in stage 2, forwarding of the next program counter value (i.e., to stage 1, where the program counter is read) can be done as early as stage 2. However, if the unit is placed on stage 3, then forwarding can be done only from stage 3 at the earliest. On the other hand, putting all the decode units in the same stage could adversely impact the critical path. The inventors considered such intricacies when selecting the pipeline boundaries. In overall, the inventors picked the pipeline boundaries that resulted in the best frequency improvement

T-piper allows the user to select any subset of forward paths from the forwarding opportunities reported. Thus, there are many possible combinations of data forwarding configurations. To limit the scope of this study, the inventors chose the set of forward paths based on two simple schemes. The first scheme forwards data only from the earliest possible forward points (ASAP), while the second performs forwarding whenever possible (MAX).

Although the system 10 can generally handle value prediction on any system state, in this study the inventors only attempted to predict the program counter (PC), which is the most common predictor for processor pipelines. In the baseline case, the inventors added a next-PC (NPC) predictor that assumes branches are not taken and guesses the execution always proceeds to the instruction immediately following the current one (in other words, the NPC predictor is effectively predicting the instruction length of the current instruction being fetched). In the second case, the incorporated a bimodal predictor that uses 2-bit saturation counters and a branch target buffer (BTB) to guess the direction and target address of branch instructions. To determine an appropriate size for these predictors, the inventors conducted trace-based simulations, and picked the size at the saturation point of the prediction accuracy curve. The inventors ended up with 256 entries for the NPC predictor's memorization table, and 16 entries for the bimodal predictor's BTB. The inventors also needed to choose the schemes to forward predicted values. Since the PC is read and written by every transaction, a transaction NPC guess is needed by only the transaction immediately after it and no one else. Therefore, the MAX forwarding scheme does not add any additional benefit over the ASAP scheme. Thus, the inventors evaluated only the ASAP scheme for forwarding scheme for NPC prediction.

The inventors evaluated two different prediction resolution schemes. The first scheme resolves prediction at the latest possible point (ALAP), which minimizes the amount of resolution logic to compare the predicted value against the actual value. The second scheme resolves prediction at the earliest points (ASAP), which reduces misprediction penalty at the cost of increased resolution logic since there can be multiple places where the predicted value is compared against the actual value).

This study used nine (9) benchmark applications from the SPREE collections (see P. Yiannacouras, J. G. Steffan, and J. Rose, “Exploration and Customization of FPGA-Based Soft Processors”, IEEE Transactions on Computer Aided Design of Integrated Circuits and Systems, Vol. 26, No. 2, 2007), which consists of benchmarks from Mibench (see M. R. Guthaus, J. S. Ringenberg, D. Ernst, T. M. Austin, T. Mudge, R. and B. Brown, “MiBench: A Free, Commercially Representative Embedded Benchmark Suite”, Workshop on Workload Characterization, 2001), XiRisc (see F. Campi, R. Canegallo, and R. Guerrieri, “IP-reusable 32-bit VLIW RISC core”, European Solid-State Circuits Conference, 2001), and RATES (see L. Shannon and P. Chow, “Standardizing the Performance Assessment of Reconfigurable Processor Architectures”, Field-Programmable Custom Computing Machines, 2003) that have been stripped of system and I/O instructions. Table 1 below offers a description of each benchmark.

TABLE 1
Benchmark applications under study.

| Name | Description |
|---|---|
| bitcnt | counts the number of bits in an array of integers |
| bubble_sort | performs the bubble sorting algorithm |
| crc | cyclic redundancy check |
| des | performs the 16 rounds in data encryption standard |
| fft | fixed point fast fourier transform |
| fir | finite impulse response filter |
| iquant | Inverse quantization algorithm for MPEG and |
| | JPEG encoding |
| quant | quantization algorithm used in JPEG compression |
| vlc | variable Length coding for JPEC and MPEG compression |

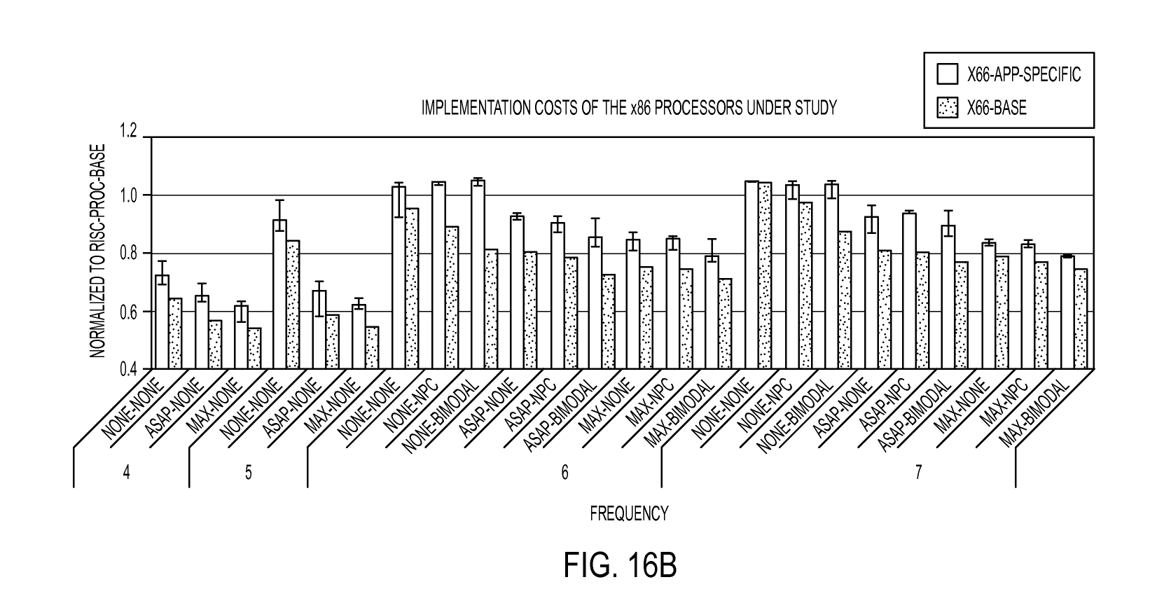

The evaluation framework is shown in FIG. 13. First, Simics full-system simulator (see P. Magnusson et al., “Simics: A Full System Simulation Platform”, Computer, vol. 35, no. 2, 2002) was used to simulate an x86 system and generate reference traces containing final architectural states for each instruction executed by the benchmarks. The trace also contains initial architectural and memory states used to initialize the pipeline RTL model. Next, Verilator (see W. Snyder, “Verilator”, http://www.veripool.org/wiki/verilator) was used to convert the RTL Verilog description of the pipeline to C++. Then, this RTL C++ model was integrated with a C++ trace processing application that executes the RTL model and performs validation by comparing the traces from the model with the reference traces. For performance analysis, the number of clock cycles and instructions executed by each benchmark was also collected. To obtain implementation costs, the pipelines were synthesized with Synopsys Design Compiler (Synopsys Design Compiler. http://www.synopsys.com) targeting a commercial 180 nm standard cell library and memory compiler.

The result of the design space exploration is summarized in Tables 2, 3, 4, and 5. The data points in these tables show the relative percentage improvement of each pipeline variant over the baseline pipeline (i.e., a 4-stage design without any data forwarding or speculation). Note that the cycle count, frequency, performance, and area of the baseline 4-stage pipeline are 29,086 cycles, 111 MHz, 24.1 MIPS, and 3.09 mm², respectively. For all the tables, the first major column shows all the pipeline configurations studied (excluding the different pipeline depths), while the second major column show the results categorized into minor columns for the different pipeline depths. Tables 2 and 3 show the execution clock cycle count from RTL simulation and implementation frequency from synthesis, respectively. Table 4 shows the performance in terms of Million Instructions Per Second (MIPS), averaged over all the benchmarks used the evaluation. For each benchmark, the MIPS rating is calculated by considering the number of instructions executed, the clock cycle count needed to execute the benchmark (Table 2), and the implementation frequency (Table 3). Table 5 shows the implementation area obtained from Design Compiler synthesis. The key insights from the results in Tables 2, 3, 4, and 5 are explained in the following subsections.

TABLE 2
Cycle counts for each of the x86 processor pipelines evaluated.

| Pipeline configuration | | | | Pipeline stages | | | |
|---|---|---|---|---|---|---|---|
| Row | P-type | P-res | D-fwd | 4 | 5 | 6 | 7 |
| 1 | None | None | None | 0.0 | −23.7 | −47.5 | −71.2 |
| 2 | | | ASAP | 50.0 | 38.9 | 30.0 | 19.3 |
| 3 | | | MAX | 62.4 | 52.0 | 38.8 | 29.9 |
| 4 | NPC | ALAP | None | 29.2 | 15.5 | 5.1 | −8.6 |
| 5 | | ASAP | | 29.2 | 15.5 | 5.1 | −8.6 |
| 6 | | ALAP | ASAP | 50.0 | 38.9 | 32.2 | 21.6 |
| 7 | | ASAP | | 50.0 | 38.9 | 32.2 | 21.6 |
| 8 | | ALAP | MAX | 62.4 | 52.0 | 43.6 | 33.6 |
| 9 | | ASAP | | 62.4 | 52.0 | 43.6 | 33.6 |
| 10 | Bimodal | ALAP | None | 32.4 | 20.1 | 10.0 | −2.6 |
| 11 | | ASAP | | 32.6 | 20.5 | 10.5 | −2.3 |
| 12 | | ALAP | ASAP | 50.0 | 38.9 | 31.9 | 21.3 |
| 13 | | ASAP | | 50.0 | 38.9 | 32.0 | 21.4 |
| 14 | | ALAP | MAX | 62.4 | 52.0 | 43.1 | 33.3 |
| 15 | | ASAP | | 62.4 | 52.0 | 43.8 | 33.9 |

TABLE 3
Frequency for each of the x86 processor pipelines evaluated.

| Pipeline configuration | | | | Pipeline stages | | | |
|---|---|---|---|---|---|---|---|
| Row | P-type | P-res | D-fwd | 4 | 5 | 6 | 7 |
| 1 | None | None | None | 0.0 | 28.8 | 47.7 | 59.5 |
| 2 | | | ASAP | −9.0 | −13.5 | 16.2 | 26.1 |
| 3 | | | MAX | −15.3 | −16.2 | 17.1 | 19.8 |
| 4 | NPC | ALAP | None | −3.6 | 31.5 | 47.7 | 55.0 |
| 5 | | ASAP | | −4.5 | 14.4 | 44.1 | 25.2 |
| 6 | | ALAP | ASAP | −9.9 | −11.7 | 24.3 | 23.4 |
| 7 | | ASAP | | −13.5 | −14.4 | 17.1 | 20.7 |
| 8 | | ALAP | MAX | −17.1 | −18.0 | 17.1 | 34.2 |
| 9 | | ASAP | | −17.1 | −17.1 | 14.4 | 16.2 |
| 10 | Bimodal | ALAP | None | −2.7 | 31.5 | 55.9 | 53.2 |
| 11 | | ASAP | | −4.5 | 17.1 | 51.4 | 47.7 |
| 12 | | ALAP | ASAP | −11.7 | −10.8 | 19.8 | 21.6 |
| 13 | | ASAP | | −11.7 | −12.6 | 24.3 | 20.7 |
| 14 | | ALAP | MAX | −17.1 | −19.8 | 14.4 | 16.2 |
| 15 | | ASAP | | −17.1 | −16.2 | 16.2 | 20.7 |

TABLE 4
MIPS performance for each of the x86 processor
pipelines evaluated.

| Pipeline configuration | | | | Pipeline stages | | | |
|---|---|---|---|---|---|---|---|
| Row | P-type | P-res | D-fwd | 4 | 5 | 6 | 7 |
| 1 | None | None | None | 0.0 | 5.4 | 2.3 | −4.2 |
| 2 | | | ASAP | 75.2 | 39.0 | 64.6 | 56.6 |
| 3 | | | MAX | 115.9 | 69.8 | 87.2 | 69.3 |
| 4 | NPC | ALAP | None | 36.4 | 56.5 | 58.8 | 46.1 |
| 5 | | ASAP | | 35.1 | 36.1 | 54.9 | 18.0 |
| 6 | | ALAP | ASAP | 73.4 | 41.9 | 80.7 | 57.3 |
| 7 | | ASAP | | 66.5 | 37.6 | 70.2 | 53.9 |
| 8 | | ALAP | MAX | 111.3 | 66.1 | 104.4 | 101.3 |
| 9 | | ASAP | | 111.3 | 67.9 | 99.6 | 74.3 |
| 10 | Bimodal | ALAP | None | 44.2 | 65.8 | 77.4 | 53.1 |
| 11 | | ASAP | | 42.1 | 48.5 | 73.4 | 48.4 |
| 12 | | ALAP | ASAP | 70.0 | 43.4 | 73.0 | 53.6 |
| 13 | | ASAP | | 70.0 | 40.5 | 80.2 | 53.2 |
| 14 | | ALAP | MAX | 111.3 | 62.5 | 98.0 | 72.3 |
| 15 | | ASAP | | 111.3 | 69.8 | 104.1 | 81.8 |

TABLE 5
Area for each of the x86 processor pipelines evaluated.

| Pipeline configuration | | | | Pipeline stages | | | |
|---|---|---|---|---|---|---|---|
| Row | P-type | P-res | D-fwd | 4 | 5 | 6 | 7 |
| 1 | None | None | None | 0.0 | −9.3 | −10.7 | −14.8 |
| 2 | | | ASAP | −18.6 | −20.3 | −20.4 | −24.0 |
| 3 | | | MAX | −23.9 | −26.0 | −30.1 | −32.1 |
| 4 | NPC | ALAP | None | −22.3 | −32.6 | −34.7 | −32.7 |
| 5 | | ASAP | | −23.3 | −30.0 | −36.8 | −36.0 |
| 6 | | ALAP | ASAP | −40.2 | −44.7 | −35.9 | −47.8 |
| 7 | | ASAP | | −39.0 | −43.4 | −44.5 | −48.5 |
| 8 | | ALAP | MAX | −45.5 | −48.3 | −53.5 | −48.3 |
| 9 | | ASAP | | −46.7 | −50.2 | −52.6 | −56.0 |
| 10 | Bimodal | ALAP | None | −34.6 | −44.6 | −44.8 | −50.1 |
| 11 | | ASAP | | −35.0 | −43.3 | −40.1 | −51.7 |
| 12 | | ALAP | ASAP | −51.4 | −56.0 | −56.5 | −59.9 |
| 13 | | ASAP | | −50.8 | −56.4 | −54.5 | −60.8 |
| 14 | | ALAP | MAX | −57.3 | −60.7 | −63.0 | −67.2 |
| 15 | | ASAP | | −61.0 | −65.6 | −58.8 | −68.1 |

The first row of Tables 2, 3, 4, and 5 show the evaluation results for the pipelines without any forwarding or speculation. As expected, having more pipeline stages breaks down the critical paths for improved frequency. However, cycle count increases for the longer pipelines due to the increased number of stall cycles that are needed to resolve data hazards. In terms of the overall MIPS performance, the 5-stage pipeline leads to the most improvement relative to the 4-stage pipeline; the 7-stage pipeline actually performs worse than the 4-stage. Lastly, deeper pipelining leads to larger area, due to the extra resources to implement the additional stages.

The second and third rows of Tables 2, 3, 4, and 5 show the evaluation results for the pipelines that have data forwarding, but do not have speculation. As expected, cycle count improves for the more aggressive forwarding schemes since data hazards are resolved earlier, thereby reducing the amount of stalls. However, the addition of forwarding logic can adversely impact critical path delay, as can be seen in the reduction in the implementation frequency. Nevertheless, data forwarding is still beneficial for overall performance, as indicated by the large improvement in MIPS. Also, the area increase due to the forwarding logic is small (up to 32% over baseline) relative to the MIPS performance improvement (up to 116%).

Rows 4 to 9 of Tables 2, 3, 4, and 5 show the evaluation results for the pipelines with the NPC predictor. Relative to the pipelines without any forwarding or speculation (i.e., row 1 vs. row 4), the NPC predictor improves cycle count by allowing a correct new instruction to be fetched on most cycles. Furthermore, the addition of the NPC predictor does not have significant impact implementation frequency, resulting in up to 59% overall improvement in MIPS relative to the baseline pipeline. Accordingly, the addition of predictor logic incurs extra area, up to 35% in comparison with the baseline.

If the addition of NPC predictor is compared against the addition of data forwarding (i.e., row 4 vs. rows 2 and 3), having a NPC predictor does not improve cycle count as much as having data forwarding. This is because the NPC predictor allows for fast hazard resolution only for program counter (i.e., EIP in x86), while data forwarding provides fast hazard resolution for all the architectural states. Furthermore, the NPC predictor requires some warm-up time before it can start making good predictions. During this period, data hazards on EIP are resolved by stalling the instruction fetch. In terms of frequency, data forwarding increases critical path more than NPC predictors. Overall, however, MIPS performance gain from only having data forwarding is higher than the gain from only having an NPC predictor in a pipeline. In terms of area, at the chosen table size, the NPC predictor consumes more implementation area than data forwarding. Thus, in this case study, having data forwarding is overall more efficient than having an NPC predictor.

The NPC predictor can also be combined with data forwarding (i.e., rows 6 to 9 in Table 2), which further improves cycle count in deeper pipelines (6- and 7-stage). However, for shorter pipelines (4- and 5-stage), data forwarding can already resolve hazards very early (i.e., EIP forwarded from stage 2 to stage 1), therefore the NPC predictor does not provide any additional benefit. In comparison with pipelines with only data forwarding (i.e., rows 2 and 3 in Table 3), having the additional NPC predictor (i.e., rows 6 to 9 in Table 3) does not worsen the implementation frequency significantly. Thus, the improvements in cycle count from having an NPC predictor in the longer pipelines do translate to overall MIPS performance gains. Finally, the prediction resolution schemes do not affect cycle count in the case of NPC predictor (i.e., rows 4, 6, and 8 vs. rows 5, 7, and 9 in Table 2). This is because there is no use of self-modifying code in the benchmarks. The NPC predictor simply remembers the length of previously seen instructions to predict the next instruction to fetch. Without self-modifying code, the NPC predictions would be correct except in the case of a taken branch. In terms of frequency (Table 3), the ALAP resolution scheme permits much higher frequency than the ASAP scheme. This is because in ASAP scheme, there are multiple prediction checks in the pipeline, which lead to increased critical path. With comparable effect on cycle count, the overall MIPS (Table 4) is also better with the ALAP schemes than the ASAP scheme. In terms of area (Table 5), one might expect that ALAP will consume less area, but in practice the total implementation area is dominated by interconnection resources rather than the prediction check logic. In this case, no consistent trends indicating whether ALAP is better than ASAP scheme were observed in terms of area, or vice versa.

Adding a Bimodal predictor lets speculation on branch instructions to reduce the lost fetch cycles after a taken branch. Rows 10 to 15 of Tables 2, 3, 4, and 5 show the evaluation results for pipelines with the Bimodal predictor. For pipelines without forwarding (rows 1, 4, and 5), the benefits of having a Bimodal predictor in improving the cycle counts (Table 2) can be seen clearly. However, for the pipelines with data forwarding, this is not the case. As with the NPC predictors, the Bimodal predictor does not provide much benefit for the shorter 4- and 5-stage pipelines, since branch target calculation for these pipelines can already be directly forwarded from stage 2 to stage 1 (incurring no stalls). For the longer 6- and 7-stage pipelines, the benefit depends on the interplay between the amount of the misprediction penalty and the benefit of having a correct prediction. For the pipelines with ALAP prediction resolution (rows 12 and 14), the overall misprediction penalty is larger than the stalls avoided from having correct predictions. Thus, Bimodal predictor is not beneficial for these shorter pipelines. For 6- and 7-stage pipelines with the more aggressive ASAP prediction resolution scheme and the MAX data forwarding scheme, the Bimodal prediction can improve cycle count, albeit only slightly.

Having a Bimodal predictor on top of an NPC predictor does not worsen the overall implementation frequency (i.e., rows 4 to 9 vs. rows 10 to 15 in Table 3). In terms of overall performance, the Bimodal predictor improves MIPS rating relative to pipelines without data forwarding (i.e., rows 10 and 11 vs. rows 4 and 5 in Table 4), but it does not help much for the pipelines with data forwarding already in place. Finally, the area (Table 5) increases accordingly as the Bimodal predictor is added.

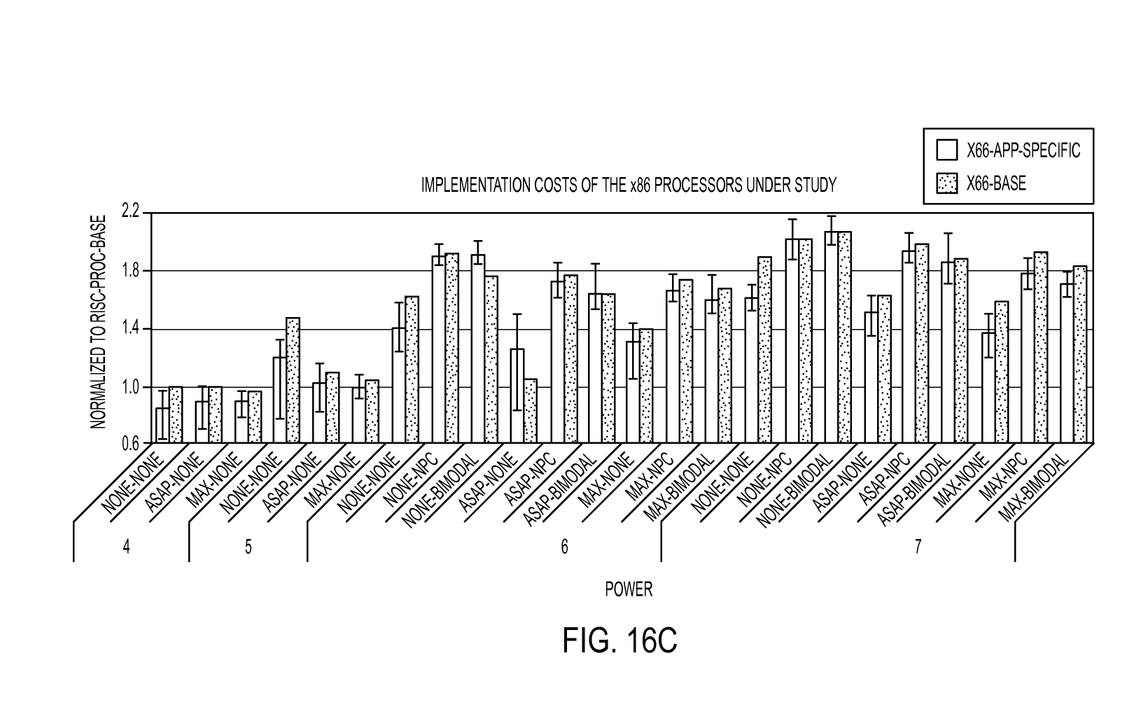

FIG. 14(a) depicts the overall tradeoff between cost (area) and performance (Average MIPS over all of the benchmarks studied). As shown in the figure, the synthesized pipelines vary in their implementation cost and performance, providing a wide range of implementation alternatives to choose from depending on the desired target. In overall, it was found that the Pareto optimal fronts consist of shorter pipelines (4- and 5-stage) without any speculation. Note that such insights on the design tradeoff for the pipelines and benchmarks studied would have been difficult to learn without exploring many RTL designs by simulation and synthesis.

There is also an opportunity for application-specific pipeline customization since the Pareto fronts would change when optimizing for individual applications instead of an average. For example, FIG. 14(b) shows the tradeoff graph for the Quant application only. As the figure shows, the Pareto fronts for Quant includes longer pipelines with speculation. The automatic pipeline synthesis capability of T-spec and T-piper makes it possible to customize and pick the best pipeline for a specific target application.

In their 1991 paper, Bhandarkar and Clark measured a performance advantage of RISC over CISC in the context of in-order pipelined implementations of MIPS and VAX processors. See D. Bhandarkar and D. Clark, “Performance from Architecture: Comparing a RISC and a CISC with Similar Hardware Organization”, International Conference on Architectural Support for Programming Languages and Operating Systems, 1991. Beyond performance, CISC ISA processors also suffer from an increased cost in implementation area and power in order to capture the greater variety of instruction behaviors. These differences between RISC versus CISC have been largely neutralized in the realm of high-performance processors today where superscalar out-of-order execution is the norm. However, RISC ISAs still dominate the embedded processor domain where simple microarchitectures are common, with great attention paid to the design efficiency in terms of area and power. Another study by the inventors investigated the opportunity to close the gap between CISC and RISC ISAs in in-order pipelined embedded processors when assuming a CISC processor can be customized to support only a particular target application's execution.

To maintain ISA compatibility, CISC processors are excessively burdened by a large number of instructions with a large variety of behaviors. In a very complicated CISC ISA like x86, many instructions, especially the complicated ones, are not used by the compilers. Some instructions are used only for OS bootstrapping. Some instructions are maintained solely for legacy compatibility. In a custom embedded processor tailored made for a particular application, the overheads associated with those unused instructions can be avoided. Provided a sufficient subset of instructions is included, these customized processors with an incomplete native ISA support could nevertheless provide full ISA compliance by emulating the missing instructions in software (e.g., by trapping to PAL code) when necessary, albeit at a large performance penalty. Yiannacouras, et al. (see P. Yiannacouras, J. G. Steffan, and J. Rose, “Exploration and Customization of FPGA-Based Soft Processors”, IEEE Transactions on Computer Aided Design of Integrated Circuits and Systems, Vol. 26, No. 2, 2007) previously showed the opportunity to improve a RISC processor's performance-per-area metric by 25% by (1) pruning the processor's datapath to support only the instructions required by a particular application (i.e., ISA subsetting) and (2) tuning the processor's microarchitecture (pipeline depth, forwarding paths, etc.) to the application's specific execution behavior. This case study evaluates the opportunity to improve performance, area, and power by making similar application specific customizations in x86 processor implementations. The results, provided below, show that application-specific customizations can significantly reduce the overhead in performance, area and power of an x86 processor relative to a RISC processor.

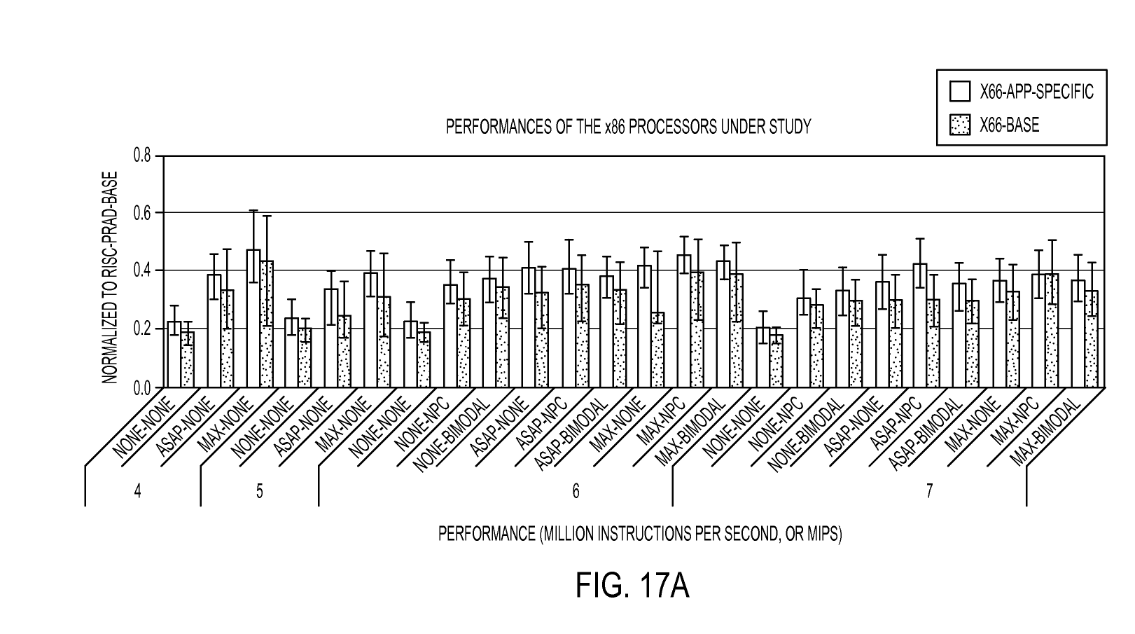

This study considers the application-specific customization flow illustrated in FIG. 15(a). Given the binary executable of a target application, an ISA specification, and an optimization objective, the goal of processor customization flow is to arrive at a processor implementation that can execute the unmodified binary of the target application and best maximizes the optimization objective.

At the ISA level, the subset of the ISA that is exercised by the target application is identified. The support for the unused instructions is later omitted from the implementation in hope to reduce implementation cost and clock cycle time. Such “ISA subsetting” was previously shown to be effective in reducing the performance-per-area metric by 25% on average in the context of RISC processor design. Yiannacouras, et al., supra. It is expected that the benefit of ISA subsetting to be larger for a CISC ISA like the x86, since it encompasses much more unused instruction behaviors.

At the microarchitecture level, the microarchitecture design space for the pruned ISA is explored to identify an instance that maximizes the optimization objective. This study considers the microarchitecture space of in-order pipelined processors with a well supported suite of options for data forwarding and speculative execution, which is suitable for “lean” processor implementations for applications with high-performance requirement, yet with strict constraints in power and area. As such, this choice of design space is relevant for many embedded application contexts.

Note that while these application-specific customization techniques by themselves are not new, this case study provides new insights by demonstrating their applications to reduce the overhead of supporting the popular x86 CISC ISA in in-order pipelined embedded processor designs. This study is made possible by T-spec and T-piper that enable the rapid design exploration of in-order pipelined processors, capable of supporting sophisticated ISA such as the x86.

The application-specific customization flow outlined in FIG. 15(a) could be realized in many ways. However, extensive use of design automation is needed to practically explore any nontrivial problem instances. FIG. 15(b) shows the actual realization of the flow in a form of a design automation toolchain that leverages T-spec and T-piper.

The toolchain takes as its first input a checkpointed initial memory image, which includes the application binary. This initial memory image is prepared using the Simics simulator (see P. Magnusson et al., “Simics: A Full System Simulation Platform”, Computer, vol. 35, no. 2, 2002) so the execution of the application can be bootstrapped directly from the start of the application. The second input is the ISA specification, written in T-spec. The final input is an optimization objective to be maximized. In this study, objectives that include wall-clock-time performance, implementation area, power dissipation, as well as the normalized metrics of performance-per-area and performance-per-Watt were considered.

The toolchain simulates the execution of a target application against the Verilog RTL implementation that corresponds directly to the T-spec specification (without any pipelining transformations or optimizations). The simulation is instrumented to collect profiling data about the usage frequencies of at different parts of the datapath (e.g., usage frequencies of different parts of the decoder module, functional units, etc). The profiling results are used to back-annotate the T-spec specification to identify unused portions of the datapath to be omitted from the pipelined implementations generated in the next step.

The Microarchitectural Customization step explores the microarchitectural design space to select an implementation of the pruned T-spec datapath that best maximizes the chosen optimization objective. From a T-spec specification, rapid design space exploration (similar to the case study presented earlier) is done by submitting different pipeline configurations to T-piper that controls the number and the positions of the pipelines stages and specifies where to apply forwarding and value-prediction optimizations to mitigate the penalty of data dependency stalls.

For the MIPS baseline processor, the 5-stage pipelined processor from the case studies previously discussed was used, which has been shown to be comparable to a hand-made implementation, as well as one generated by SPREE. For the x86 CISC baseline implementation, the T-spec datapath in the case study described earlier was used. From the T-spec, T-piper was used to generate a 7-stage pipeline with a maximal data-forwarding network and a bimodal branch predictor based on 2-bit saturation counters. Unfortunately, there is not an open-source pipelined x86 implementation that would allow us to vet the quality of the x86 baseline implementation. Some indications by comparing the x86 CISC baseline against the MIPS baseline were gleaned. Bhandarkar and Clark, supra, studied the relative overhead of an in-order pipelined CISC processor (Digital VAX 8700) against a RISC processor with a similar microarchitecture (MIPS M/2000). They reported a net cycle-based performance advantage of RISC over CISC (i.e., the RISC factor) of 2.7 on average, with a minimum of 1.8 and a maximum of 3.7. As a check, the RISC factor between the x86 CISC baseline and the MIPS RISC baseline was calculated to be 2.1 on average, with a minimum of 1.4 and a maximum of 2.7 over the SPREE benchmark applications tested. This comparison is again inexact but should give some support that the x86 processor pipeline is not grossly unreasonable for an in-order pipelined CISC processor.

The same set of target applications from the SPREE collection, supra, was considered as in the previous case study. Refer to Table 1 for a brief description of each application.

For each application under study, the flow presented above was used first to prune the unused instructions from the x86 ISA and then to generate a variety of implementations corresponding to different microarchitecture optimizations. During ISA subsetting, the following datapath support could become removed when they are made non-essential by pruned instructions:
various parts of the decoder (i.e., decoder table, instruction length calculator, control logic generation, immediate value decoding) corresponding to pruned instructions;
various parts of the ALU (i.e., operand packing/unpacking logic, functional units, multiplier, divider) used by specific pruned instructions;
various parts of the flags calculation logic;
various parts of the memory address calculation logic; and
multiplexers associated with aforesaid modules (e.g., pruning out a multiplier unit leads in removal of the multiplexer input that the multiplier is connected to).

From either the original full x86 T-spec or the pruned version, T-piper was used to generate various pipelined implementations using pre-prepared pipeline configuration scripts (i.e., a total of 240 pipelined implementations were studied). The configurations visited cover a design spanned by the orthogonal design choices used in the previous case study, i.e., varying pipeline depths from 4 to 7 stages; forwarding schemes from no forwarding (None), forwarding as soon as the value is computed (ASAP), and forwarding whenever possible (Max); and speculation schemes from no speculation (None), with a next-PC (NPC) predictor, and with a both NPC and bimodal predictors (Bimodal).

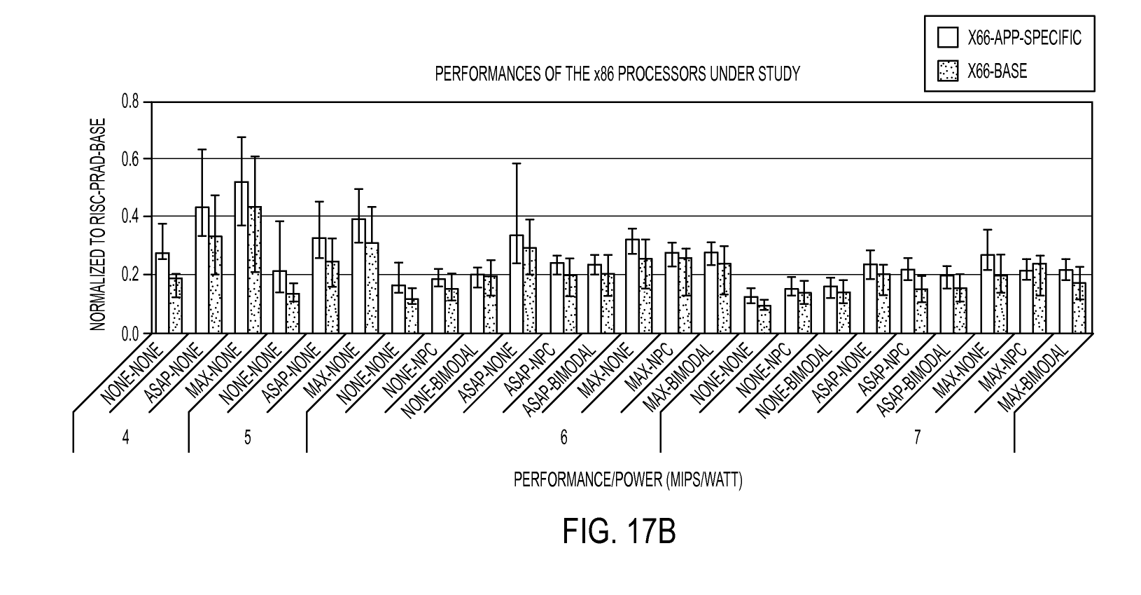

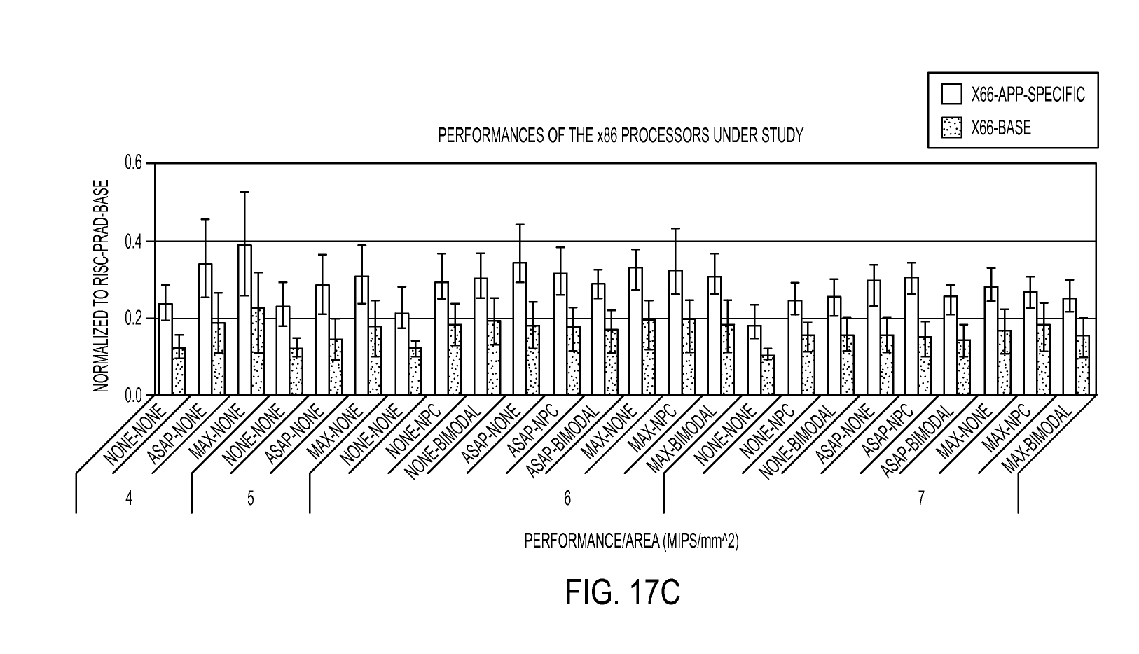

The results from the evaluation are summarized in FIG. 16 and FIG. 17. For each target application, a corresponding subsetted x86 T-spec and T-piper were used to create a range of implementations according to the microarchitecture space described above. In this series of figures, the X-axis lists the different microarchitectures evaluated by the automatic development toolchain. The labels are in the format of {pipeline depth, forwarding scheme, speculation scheme}. For example, 7-Max-Bimodal refers to the 7-stage pipelined instance with maximum forwarding and a Bimodal predictor. The Y-axis shows the area, frequency, power, or performance averaged over the nine target applications and normalized to the baseline RISC processor. The x86-base bars show the values for the processor without any ISA subsetting, while the x86-app-specific bars show the processors with ISA subsetting given each target application. The x86-app specific bars show the average value across each of the target application. The range markers represent the minimum and maximum values.

As shown in FIG. 16(a), ISA subsetting effectively reduce implementation area relative to the x86-base, averaging in 33% of area reduction. For several microarchitectures, the reduction brings the area down to a level comparable to the area of the RISC processor baseline (e.g., pipelines without any forwarding or speculation). In terms of frequency, the improvement is not as much as area, averaging in 12% frequency improvement (FIG. 16(b)). This is because the target applications still utilize several CISC instructions. Therefore, even with ISA subsetting, it is not possible to purely eliminate the support for CISC-style instructions. As such, the critical path of the CISC datapath does not get significantly affected by ISA subsetting.

As depicted in FIG. 16(c), power dissipation of an ISA subsetted processor is not always lower than the non-subsetting x86-base processor (e.g., 6-stage, ASAP forwarding, no speculation). This is because the increase in frequency may lead to larger increase in power dissipation relative to the power savings afforded by the reduced area. In overall, ISA subsetting leads to an average of 6% reduction in power dissipation. Also, for some microarchitectures (i.e., 4-stage pipelines), this reduction leads to power dissipation lower than that of the RISC baseline.

The performances for the processors under study are shown in FIG. 17. Three performance metrics are observed. The millions of instructions per second (MIPS) depends only on the implementation frequency and the cycle-per-instruction (CPI) performance of the microarchitecture, without any consideration to power or area overheads. The MIPS/Watt and MIPS/mm2 consider the power and area overheads, respectively. Since the ISA subsetting preserves datapath correctness and targets purely unused parts of the datapath, CPI of a subsetted processor remains the same to the non-subsetted x86-base processor (i.e., subsetting has no impact on microarchitecture effectiveness). Therefore, the improvement in MIPS performance is resulted from the frequency increase only. As such, the ISA subsetting reduces the CISC-to-RISC performance gap in MIPS (FIG. 17(a)) by 12% on average (i.e., from an average of 3.1× the performance of the RISC processor baseline, down to 2.8×).

When power is considered (FIG. 17(b)), the modest additional average power savings of 6% leads the larger reduction in the CISC-to-RISC gap in performance-per-Watt, averaging in 17% reduction (from 4.7× down to 3.9×). When area is considered (FIG. 17(c)), the significant 33% savings from subsetting yields a 40% average reduction in the CISC-to-RISC performance-per-area gap, from an average of 5.9× down to 3.5×. Note that, as expected, this 40% improvement in performance-per-area metric is larger than the 25% improvement of the same metric that was reported in Yiannacouras et al. when applying ISA subsetting on a RISC processor.

Looking at the results in FIG. 16 and FIG. 17 more holistically, comparing the results across the X-axis, the dramatic effect of microarchitecture customization for both the x86-base and x86-app specific sets of processors can clearly be seen. The microarchitecture customizations explored by the T-piper toolchain are beneficial in providing a wide range of implementation options to choose from. The design space, starting from the simplest microarchitecture (4-None-None) and ending at the most aggressive one (7-Max-Bimodal), covers a large range of implementation costs and performances. For example, for the x86-base processors (i.e., without ISA subsetting), the area, frequency, and power can vary by 1.4×, 1.9× and 2.1×, respectively. Performance in terms of MIPS, MIPS/Watt, and MIPS/mm2 vary by 2.2×, 4.4×, and 2×, respectively. These large variations exist in the x86-app-specific processors (i.e., with ISA subsetting) as well. Variations in area, frequency, and power for these processors are 1.5×, 1.7×, and 2.4×, respectively. For performance, they are 2.3×, 4.1×, and 2.1× in terms of MIPS, MIPS/Watt, and MIPS/mm2 The large variations provide customization opportunity by selecting the best microarchitecture instance to satisfy the desired optimization objective.

Tables 6, 7, and 8 below show the characteristics of the best application-specific x86 processor generated by the T-piper toolchain for each of the application under study, when optimized for performance (MIPS), performance/power (MIPS/Watt), and performance/area (MIPS/mm2), respectively. The tables provide the microarchitecture selected as the best processor, along with the power, area, and performance of the processor. Each of these metrics are shown both in terms of their absolute values normalized to RISC baseline, and as percentage of improvements relative to the non-subsetted x86 baseline processor with the most aggressive 7-Max-Bimodal microarchitecture. The absolute values indicate the CISC-to-RISC gap, while the percentages show the benefits of applying the application-specific customizations relative to a non-customized x86 processor. Lastly, the table provides the performance range to provide insights of alternative design points (that gives median and minimum performance) aside from the best performing design. Notice that most of the best designs are at a significantly higher performance level than the median and minimum designs.

TABLE 6
x86 application-specific processors with the best performance.

| | | | | | Performance |
|---|---|---|---|---|---|
| Target | Micro- | | | | range |
| application | architecture | Power | Area | Performance | (median, min) |
| Bitcnt | 4-Max-None | 0.86 (+53%) | 1.26 (+41%) | 0.51 (+58%) | 0.34, 0.17 |
| Bubble_sort | 4-Max-None | 0.88 (+52%) | 1.06 (+50%) | 0.56 (+56%) | 0.39, 0.18 |
| Crc | 4-Max-None | 0.79 (+57%) | 1.10 (+49%) | 0.41 (+44%) | 0.31, 0.16 |
| Des | 4-Max-None | 0.89 (+52%) | 1.15 (+46%) | 0.46 (+57%) | 0.30, 0.15 |
| Fft | 6-Max-Npc | 1.72 (+7%) | 1.50 (+30%) | 0.52 (+22%) | 0.45, 0.24 |
| Fir | 4-Max-None | 0.96 (+48%) | 1.23 (+43%) | 0.51 (+35%) | 0.42, 0.26 |
| Iquant | 7-Asap-Npc | 2.01 (−9%) | 1.47 (+31%) | 0.44 (+23%) | 0.39, 0.26 |
| Quant | 7-Asap-Npc | 2.07 (−12%) | 1.54 (+28%) | 0.41 (+23%) | 0.36, 0.23 |
| Vlc | 4-Max-None | 0.90 (+51%) | 1.31 (+39%) | 0.61 (+59%) | 0.41, 0.19 |

TABLE 7
x86 application-specific processors with the best performance/power.

| | | | | | Performance |
|---|---|---|---|---|---|
| Target | Micro- | | | | range |
| application | architecture | Power | Area | Performance | (median, min) |
| Bitcnt | 4-Max-None | 0.86 (+53%) | 1.26 (+41%) | 0.59 (+238%) | 0.23, 0.11 |
| Bubble_sort | 4-Max-None | 0.88 (+52%) | 1.06 (+50%) | 0.64 (+228%) | 0.25, 0.12 |
| Crc | 4-Max-None | 0.79 (+57%) | 1.10 (+49%) | 0.52 (+239%) | 0.20, 0.11 |
| Des | 4-Max-None | 0.89 (+52%) | 1.15 (+46%) | 0.52 (+224%) | 0.20, 0.10 |
| Fft | 4-Max-None | 0.87 (+53%) | 1.32 (+38%) | 0.51 (+123%) | 0.27, 0.14 |
| Fir | 6-Asap-None | 0.84 (+55%) | 1.10 (+49%) | 0.58 (+182%) | 0.26, 0.15 |
| Iquant | 4-Max-None | 0.97 (+47%) | 1.30 (+39%) | 0.41 (+110%) | 0.24, 0.15 |
| Quant | 4-Max-None | 0.94 (+49%) | 1.25 (+42%) | 0.43 (+135%) | 0.22, 0.13 |
| Vlc | 6-Asap-None | 0.90 (+51%) | 1.31 (+39%) | 0.68 (+225%) | 0.26, 0.12 |

TABLE 8
x86 application-specific processors with the best performance/area.

| | | | | | Performance |
|---|---|---|---|---|---|
| Target | Micro- | | | | range |
| application | architecture | Power | Area | Performance | (median, min) |
| Bitcnt | 4-Max-None | 0.86 (+53%) | 1.26 (+41%) | 0.40 (+167%) | 0.27, 0.16 |
| Bubble_sort | 4-Max-None | 0.88 (+52%) | 1.06 (+50%) | 0.53 (+214%) | 0.34, 0.18 |
| crc | 4-Max-None | 0.79 (+57%) | 1.10 (+49%) | 0.37 (+182%) | 0.25, 0.16 |
| des | 4-Max-None | 0.89 (+52%) | 1.15 (+46%) | 0.40 (+191%) | 0.25, 0.14 |
| fft | 6-Asap-None | 1.49 (+19%) | 1.32 (+38%) | 0.38 (+90%) | 0.31, 0.19 |
| fir | 6-Asap-None | 0.84 (+55%) | 1.10 (+49%) | 0.44 (+149%) | 0.33, 0.23 |
| iquant | 6-Asap-None | 1.49 (+19%) | 1.28 (+40%) | 0.34 (+102%) | 0.29, 0.22 |
| quant | 6-Asap-None | 0.94 (+49%) | 1.25 (+42%) | 0.32 (+105%) | 0.25, 0.18 |
| vlc | 4-Max-None | 0.90 (+51%) | 1.31 (+39%) | 0.47 (+160%) | 0.30, 0.16 |

The application-specific customizations improves performance relative to the most aggressive x86 processor by 42%, 185%, and 151% on average for the MIPS, MIPS/Watt, and MIPS/mm2 metrics, respectively. Even with such significant improvement, there is still exists CISC-to-RISC performance gaps of 2×, 1.9×, and 2.5× for the three aforesaid performance metrics, respectively. In terms of power, an average saving of 33%, 52%, and 45% with respect to the most aggressive x86 processor was achieved when considering the MIPS, MIPS/Watt, and MIPS/mm2 metrics. More importantly, for some applications (e.g., bitcnt, bubble_sort, crc, des) such saving brings down the power dissipation to a level even lower than that of the baseline RISC processor. This is because these applications favor the shorter 4-stage pipeline, which typically consume less power than the deeper pipelined designs. Finally, the area saving relative to the most aggressive x86 processor averages to ˜40% for all the performance metrics looked at. The end result is an average of 25% CISC-to-RISC area gap. For some target applications (e.g., bubble_sort, crc, fir), this area gap is as low as 10% or less.

High-level (above RTL) design frameworks, like T-spec and T-piper, that employ design abstractions with precise semantics make it possible for designers to formally verify the properties and correctness of their initial design specifications. Unfortunately, even starting from a presumably correct specification and assuming hands-free automatic synthesis, there are ample opportunities for bugs to be introduced in the many rounds of synthesis and translation that stand between a high-level specification and its final realization. Bugs can be grouped into: (1) a fundamental error in the synthesis algorithms, or (2) a programming bug in the implementation of the synthesis algorithms. This is not a new problem. An analogous problem has long existed for the now industry standard RTL-downward synthesis flows. In less critical designs, one may simply put faith in the correctness of the synthesis tools; for critical designs, one must perform extensive functional design validation at the lowest practical intermediate representations and even on the final parts.

Taking advantage of the precise design semantics of high-level design frameworks, one should extend formal verification technologies to ensure not only the correctness of the initial specification but also its equivalence with the output of subsequent synthesis and translation. With recent advances in combining model checking (see E. Clarke, O. Grumberg, and D. A. Peled, “Model Checking”, The MIT Press, 2000) and theorem proving techniques to curtail state-explosion, compositional model checking (see K. L. McMillan, “A Methodology for Hardware Verification Using Compositional Model Checking”. Science of Computer Programming, Vol. 37, Issue 1-3, 2000) has been applied to successfully verify functional equivalence between non-trivial pipelines and their specifications. See R. Jhala, K. L. McMillan, “Microarchitecture Verification by Compositional Model Checking”, Conference on Computer Aided Verification, 2001 and A. Lungu and D. J. Sorin. “Verification-Aware Microprocessor Design,” International Conference on Parallel Architectures and Compilation Techniques, 2007. Unfortunately, the manual effort involved in compositional model checking (e.g., applying abstractions and compositional reasoning) was reported to be extremely high. See Lungu, supra.

In various embodiments, formal verification can be integrated with the T-piper high-level pipeline synthesis framework. The integration allows formally proving that the pipeline RTL output (or other synthesized hardware description) of the T-piper module 18, with its concurrent execution of transactions and the intricacies of hazard resolutions, does result in the same execution as if the transactions were executed one-at-a-time as prescribed by the T-spec transactional semantics. The verification can be performed by execution of the verification module 20 (see FIG. 1).

In various embodiments, the T-piper module 18 is extended to use Cadence SMV compositional model checker (see K. L. McMillan, “Getting Started with SMV”, Cadence Berkeley Laboratories, 2001) to automatically verify the functional equivalence between the input T-spec 22 and the output pipeline implementation 28. Furthermore, to make the system practical, the T-piper module 18 may automatically apply abstraction and compositional reasoning techniques, therefore avoiding the need for manual compositional model checking effort.

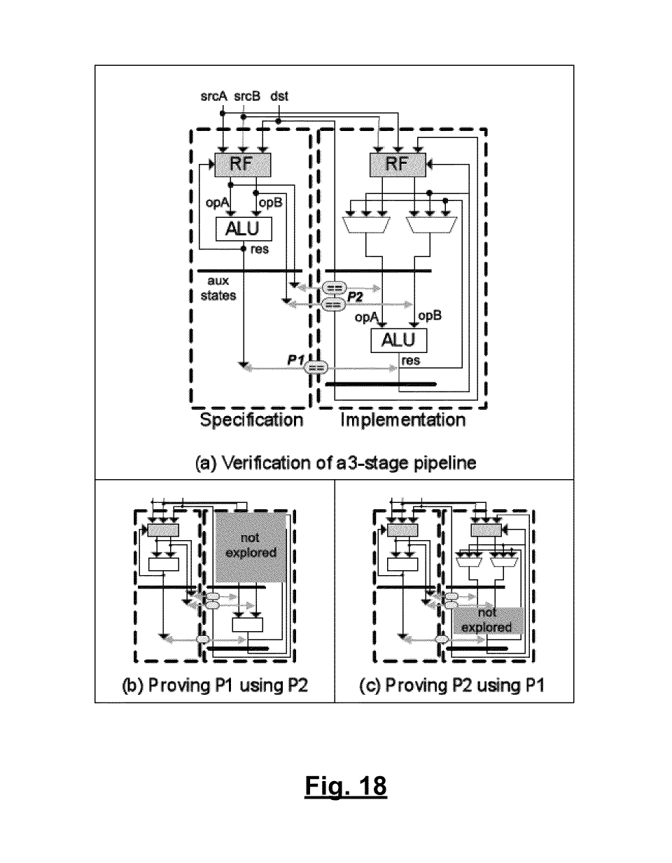

A simple example from McMillan, supra, can be used to explain the process of compositional model checking and to highlight the high level of sophistication and manual effort involved. The left-portion of FIG. 18(a) (designated “Specification”) shows a simple non-pipelined 32-bit processor datapath that only supports ALU instructions. Each ALU instruction reads two operands from the register file (RF); performs an ALU operation; and writes the result back to the RF. The right-portion of FIG. 18(a) (designated “Implementation”) depicts a 3-stage pipelined datapath with maximal data forwarding support.

To verify that the Specification and the Implementation are functionally equivalent, cycle-accurate and (at least initially) bit-true RTL models are first created for both the Specification datapath and the Implementation datapath. Next, a pipeline correctness property to be checked is devised. To prove functional equivalence of the Specification and the Implementation, a property can be set stating that following all possible instruction execution sequences, the Specification and the implementation make the same RF state updates. Since the RF state update value is produced by the ALU, which depends on the RF state as input, the correctness property (“P1”) can instead require the ALU outputs in Specification and the Implementation to be the same. Because the timing of Specification and the Implementation are different, a refinement map can be created that relates the ALU output in the Implementation to the ALU output in the Specification. In this case, an auxiliary pipeline register is introduced in the Specification model to provide a delayed ALU output value that corresponds in timing with the ALU output in the implementation model.

In various embodiments, certain control signals to be “free” variables can be declared, indicating to the model checker to consider all possible combinations of values of those variables. In the current example, the read and write indices of the RF would be declared as free variables so that the model checker considers all combinations of reading and writing the different RF entries.

Given a correctly formulated set of (1) Specification and Implementation models, (2) the refinement map, and (3) a correctness property, a capable model checker should either prove that the property is true or produce a counter example. In practice however, even the simple pipeline in the current example could cause today's model checkers to run out of memory due to the large number of states that need to be explored (a.k.a., state explosion).

The complex functionality of the ALU (supporting a large number of 2-to-1 functions, such as multiply-and-shift) is one cause of state explosion. A standard workaround in model checking is to assume that the ALU blocks in the Specification and the Implementation are identical. Thus, they can be captured as uninterpreted functions (see McMillan, supra) in the verification model, and the model checker does not have to consider their internal details. Other details can also be abstracted such as the exact word-size of the datapath. For example, data type reduction (see McMillan, supra) can be applied to the ALU operands and output to verify the correctness property generally for unbounded word-size (which is actually much cheaper to verify than an explicit word-size).

A property that depends on many signals (i.e., has a large cone of influence) can also lead to state explosion. The correctness property P1 posed above has a cone of influence that covers the entirety of the Specification and the Implementation. Compositional reasoning (see McMillan, supra) allows a property to be decomposed, so multiple smaller (more manageable) properties can be checked instead. For example, another property P2 can be introduced that states that the ALUs in the Specification and Implementation receive the same operands. Instead of proving P1 as a standalone property, P1 can be proven separately assuming P2, and then P2 assuming P1. When proving P1 assuming P2, the cone of influence is greatly reduced from before since it is no longer necessary to consider the RF fetch logic in the Implementation. (FIG. 18(b) illustrates the part of the pipeline that can be left out when proving P1 assuming P2; FIG. 18(c) shows the same for when proving P2 assuming P1.)

Another well-known decomposition is case analysis (see McMillan, supra), which splits a proof into multiple proofs according to different assignments to a set of variables. For example, P1 can be split into multiple (smaller) cases that consider separately different combinations of ALU output and input operands. Furthermore, symmetry can be used on the 32-bit ALU's input operands to reduce the number of cases that need to be checked explicitly.

As the example shows, the manual effort needed in compositional model checking is significant. Expert knowledge both in pipeline design and model checking is needed to determine the appropriate abstractions and decomposition strategies to apply. A similar sentiment was reported in a recent case study that verified RISC processor pipelines using compositional model checking. See Lungu, supra.

Automatic Verification. This section describes the verification module 20 that can be used in various embodiments to enable automatic compositional model checking to prove that the in-order pipelined implementation synthesized by T-piper executes and performs the same order of transactions and state updates as its T-spec datapath specification. In other words, the verification demonstrates that the synthesized pipelined datapath is functionally equivalent to the non-pipelined T-spec datapath under its transactional execution semantics.

In various embodiments, given the inputs of T-spec 22, P-cfg 24 and H-cfg 26 files, the verification module 20 generates a verification file 30 in, for example, the SMV language that can be directly submitted to Cadence SMV. Ideally, the RTL Verilog design should be model checked directly. The current choice of the SMV language is simply because Cadence SMV was the only capable and readily accessible compositional model checker. As is, the Verilog and SMV descriptions may be generated from a common RTL internal representation at the final step of the synthesis process. Below, after first clarifying the verification objectives, the model generation process and the proof procedure is explained.

Since the implementation pipeline in this context is automatically generated, any bug in the implementation would have to be caused by a bug in the T-piper synthesis. There are two classes of bugs that can occur: (1) a fundamental bug in the pipeline synthesis algorithms, or (2) a programming bug in the coding of the synthesis algorithms (e.g., a bug in the synthesis code, a bug in the code that checks for the validity of the input T-spec or configuration files, etc). Both types of bugs can be exposed by the verification approach described in this section.

Starting from the T-spec netlist 22, the T-piper module 18 can introduce pipeline stage registers and pipeline control logic such that the overlapped transaction executions on the synthesized pipelines produce the same result as the one-at-a-time, sequential next-state update of the T-spec model under T-spec's transactional execution semantics. The synthesized pipelined implementation can use the same next-state compute blocks (e.g., op1, op2, op3, op4, op5, and m1 in the datapath example depicted in FIG. 2(b)) as the original T-spec. Since these blocks are a part of the specification, they can be assumed to be correct and have been verified independently.

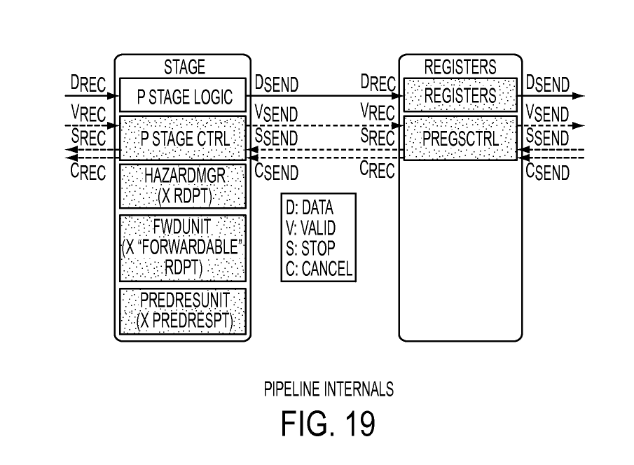

The focus of the verification effort is the correctness of the pipeline register insertion and the pipeline control logic generated by T-piper. A brief summary of the pipeline structures synthesized by the T-piper module 18 is provided here for convenience. FIG. 19 depicts the pipeline structure generated by the T-piper module 18 in various embodiments, with the pipeline control logic in the shaded blocks. In the figure, PstageLogic (pipeline stage logic) refers to the original user-provided next-state compute blocks specified in T-spec. The pipeline control logic blocks introduced by T-piper are:
PstageCtrl (Pipeline Stage Controller) interacts with the PstageLogic in a given stage and manages communication with the adjacent pipeline state registers.
HazardMgr (Data Hazard Manager) detects data hazards and activates the appropriate resolution logic. Since hazard is detected at a state read interface, one HazardMgr is generated for each state read interface in a stage.
FwdUnit (Forward Unit) manages forwarding of both actual and predicted values. It includes a forwarding multiplexer (e.g., fwd in FIG. 4(b)) and acts as a proxy to a state read interface, providing either a forwarded value or an actual state-read value. One FwdUnit is generated for each state-read interface where forwarding from a downstream stage is supported.
PredResUnit (Prediction Resolution Unit) compares a predicted value with the actual value eventually produced by the datapath. The unit triggers squash on a misprediction. One PredResUnit is generated for each PredResPt in the stage.

This section describes how the verification module 20 emits the models for use with the Cadence SMV model checker according to various embodiments. Prior to abstraction, the specification and the implementation models are cycle-accurate and bit-true representations of the non-pipelined input T-spec and the synthesized pipelined implementation, respectively. The specification model may be automatically augmented with the necessary auxiliary states and logic for the refinement mapping.

To curtail state explosion, the T-piper module 18 may generate the simplest possible models while exposing sufficient details to facilitate verification of the pipeline control logic. In the verification models, the internal details of the next-state compute blocks (PstageLogic in FIG. 19) are abstracted as uninterpreted functions. Recall that these blocks are provided by the user and are assumed to be correct as given. On the other hand, the implementation model must expose faithfully the pipeline control logic (the shaded units in FIG. 19) introduced by T-piper. To do so, the abstraction retains the following details needed by the pipeline control logic:
State elements and their read/write interfaces, which expose all possible hazards scenarios in the implementation model.
State write-data sources (e.g., outputs of op4 and op5 in FIG. 2(b)) and write multiplexers (e.g., m1 in FIG. 2(b)), which expose forwarding possibilities in the implementation.
Dataflow dependencies, which are required to maintain the correct original transactional semantics.

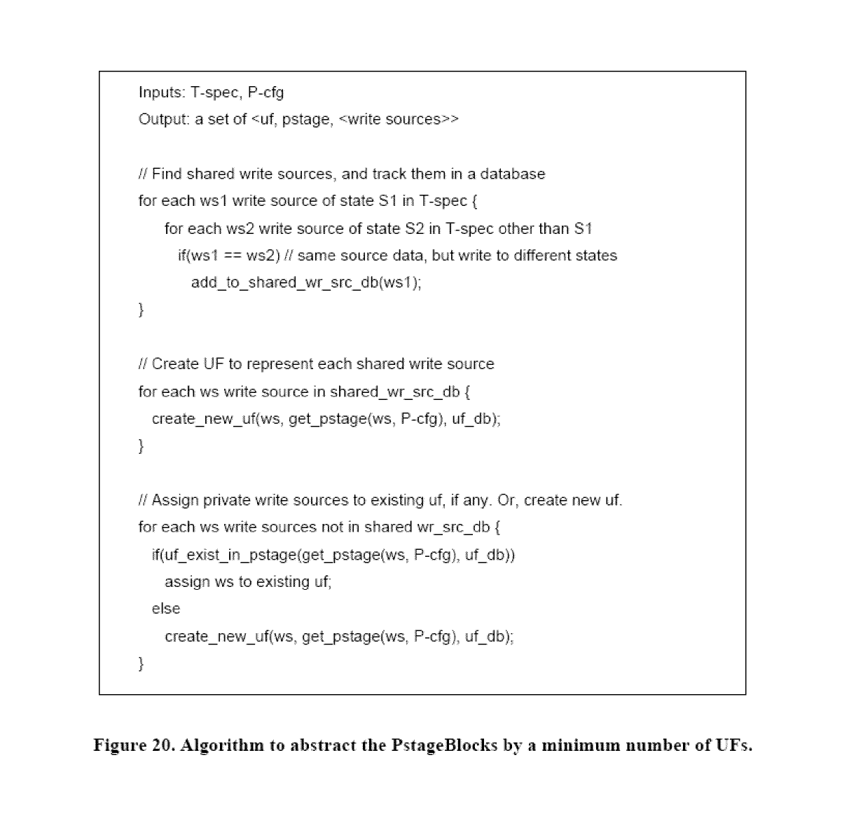

FIG. 20 illustrates the algorithm for automatic abstraction by the verification module 20. The algorithm produces a set of uninterrupted functions (UFs) and a list of state write sources that it represents. The first part (comprising the first three for-loops) considers all the write-data sources of an architectural state and allocates a minimal number of UFs to abstract the PstageBlocks of the stage(s) where the write-data originates. The final for-loop assigns a UF for the PstageBlock of any stage that has not been abstracted in the first part, ensuring that all PstageBlocks are abstracted. To minimize the number of UFs, a single UF may be used to represent multiple write-data sources where appropriate. For example, state A in a design may have write-data sources src1 and src2 that are placed at pipeline stages s1 and s2, while state B may have write data sources src3 and src4 at stages s2 and s3. In this case, only three UF's are needed to represent (1) src1 in s1; (2) src2 and src3 combined in s2; and (3) src4 in s3. Although only one UF is used to represent two write-data sources (src2 and src3) in s2, from the pipeline control logic's perspective, state B still sees two write-data sources (at s2 and s3); similarly, state A sees two write-data sources (at s1 and s2).

In various embodiments, T-piper automatically declares certain control signals as ‘free’ variables, such as with the RF read and write indices. In addition, the following signals may be declared as free variables by T-piper:
The read and write enables of each state element (and index of an array state element). Freeing these signals allows model checking to cover for all possible data hazard scenarios.
The select signal of a write multiplexer. This allows the model checker to explore state writes from all the possible write-data sources, thus uncovering all the possible data forwarding scenarios.
There is no extra analysis required to identify these signals since they are already needed by T-piper for pipeline synthesis sake.

T-piper may insert auxiliary states to buffer values produced by the specification model. These buffered values may be used to set the refinement maps and correctness properties. Details on the correctness properties synthesized by T-piper are discussed below. In addition to the auxiliary states, T-piper also may generate logic that coordinates the execution progress of the specification and the implementation models. Such coordination logic was not needed in the example presented above since the maximally forwarded pipelined implementation in the example never stalls. In general, a pipeline implementation may still need to stall when the available forwarding paths do not resolve all hazard conditions. When the coordination logic detects a pipeline stall in the implementation model, the coordination logic needs to artificially throttle the progress of the specification model to keep the two models' progress in synchronization. Since T-piper is synthesizing the pipeline control logic, the verification module knows which signals correspond to pipeline stalls and need to be monitored by the coordination logic.

When a transaction requires an architectural state value that is due to be updated by another downstream transaction and the value is not yet available through forwarding, automatic speculative mechanisms in a T-piper pipeline allow the transaction to utilize a predicted value generated by a user-provided value predictor in place of the actual state value. T-piper may automatically generate the logic to eventually check the predicted value against the actual value and, in the case of a misprediction, to restart the pipeline after squashing any affected transactions. In the case of a correct prediction, only that the predicted value is forwarded correctly needs to be verified. This is essentially the same as verifying the data forwarding logic, except with a different type of data source (i.e., value produced by the predictor logic instead of a logic block from a downstream stage). In the case of a misprediction, the following preferably is verified: (i) that the prediction resolution unit (PredResUnit) appropriately informs the pipeline control units (PstageCtrl) of the event and (2) that the pipeline is correctly squashed and restarted. In various embodiments, the verification module 20 may implement the approach in R. Jhala, K. L. McMillan, “Microarchitecture Verification by Compositional Model Checking”, Conference on Computer Aided Verification, 2001 to model speculative execution for verification. First, a free Boolean flag (e.g., isMispred) may be utilized to indicate whether a misprediction happened at a given execution step. If isMispred is asserted, then the specification model stalls to wait for the implementation model to detect the misprediction and squash the affected transactions in the pipeline. On the other hand, if isMispred is not asserted, the specification model advances normally.

Second, the transactions following a misprediction in the implementation model may be marked as ‘shadow’. They preferably are eventually squashed when the misprediction is detected. Therefore, they do not have any correspondence to those transactions executed by the specification model. These shadow transactions are tracked with a shadow bit, which may be an auxiliary state that is set when the isMispred flag is asserted and cleared when the implementation has handled the misprediction. The refinement maps are set to ignore these shadow transactions accordingly.

Finally, to verify the correctness of the forwarding logic for the predicted value, the verification mould 20 may use the value generated by the specification model as an input to the implementation model. This value is carried along the pipeline using auxiliary states, and is used to model the forwarding of a correct prediction.

In various embodiments, by default, T-spec requires each state access to be predicated by an explicit enable signal (i.e., a read/write occurs only when its enable signal is asserted). However, in some cases, a state is constrained by design to always be read (or written) by every transaction. For example, the program counter (PC) in an instruction processor is always read and written by each instruction. To further aid in simplifying the verification models, T-spec may be extended to allow the user to annotate such constraints. T-piper incorporates these constraints in the verification model. In the instruction processor example, the constraint that sets PC to always be read/written allows pruning the scenarios where PC is not read/written, which reduces the number of state transitions to be explored during model checking.

The verification module may automatically place refinement maps and specify properties to prove the correctness of:
State write value (P-wr), which states that any architectural state updates made in the implementation model should be consistent to those in the specification model. The property P1 (i.e., correctness of RF writes) is this type.
State read value (P-rd), which states that any architectural state reads made in the implementation model should be consistent to those in the specification model. The property P2 (correctness of RF reads) is this type. Note that in an implementation model with data forwarding, state read value is obtained at the output of the FwdUnit.
Uninterpreted function (UF) output (P-uf-out), which states that the output produced by each UF in the implementation model should be consistent with the one in the specification model. The property P1 is also of this type (since ALU output is the RF write data).
   The P-wr properties by themselves would be necessary and sufficient to prove functional equivalence between the specification and the implementation models. The Prd and P-uf-out properties may be included to facilitate decomposition.

The verification module 20 may automatically perform decomposition utilizing the following heuristics in various embodiments:
A P-wr property is proven by assuming that all the write-data sources are correct. Write-data sources are the earliest forwarding points (e.g., op4 and op5 in FIG. 2(b)), which are already identified by T-piper during pipeline synthesis. A write-data source is either an output of a UF (assumed correct in P-uf-out) or a state read interface (assumed correct in P-rd). The write-data source correctness assumption removes from the P-wr's cone of influence the pipeline implementation logic that computes the write-data.
A P-rd property is proven by assuming that all the possible forwarding sources to that read interface are correct. As mentioned earlier, T-piper already identified all forwarding sources. Therefore no additional analysis is needed to determine these sources. Each forwarding source should either be a UF output (assumed correct in Puf-out) or a state read interface (assumed correct in P-rd). T-piper will not create cyclic dependency in P-rd. The forwarding source correctness assumption removes from the P-rd's cone of influence the pipeline implementation logic that computes the forwarded values.
A P-uf-out property is proven by assuming that all its inputs are correct. Each of the UF inputs should either be a state read data (assumed correct in P-rd) or a UF output (assumed correct in P-uf-out). T-piper will not create cyclic dependency in P-uf-out. The assumption removes from the P-uf-out's cone of influence the pipeline implementation logic that produces the inputs to the UF.

In various embodiments, the verification module 20 may automatically perform case splitting on the aforementioned properties, as follows:
A P-wr property is split into cases that consider all possible values of each of the write-data sources to the state write-data being proven.
A P-rd property is split into cases that consider all possible values of the state read data. If the state is an array, the split also considers all possible values of the array read index.
A P-uf-out property is split into cases that consider all possible values of its output and its inputs. T-piper defines the variables involved in the case splitting as symmetric so that the model checker can perform data type reduction accordingly.

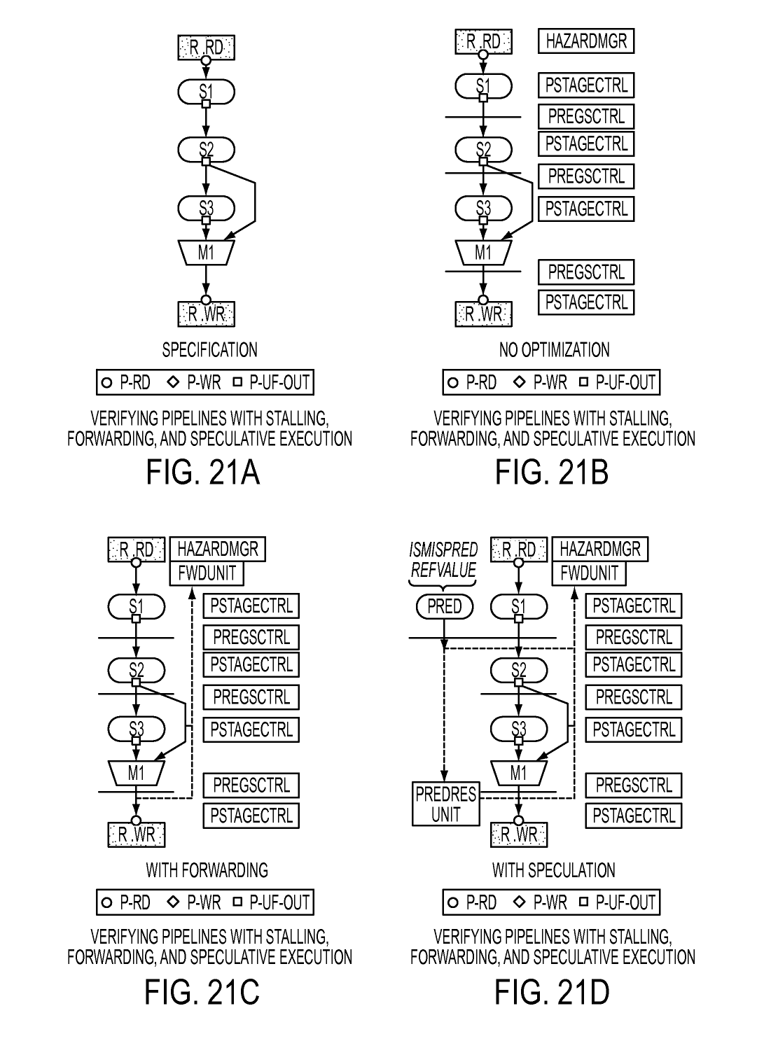

FIG. 21(a) depicts the verification model for the specification datapath derived from the T-spec in FIG. 2(b). Three UFs are needed in these models, s1, s2, and s3, corresponding to first three stages of the target 4-stage pipelines from FIGS. 5A-C. No UF is needed to represent the last pipeline stage since it has only the write interface to state R (i.e., no computational block). Notice that the next-state compute blocks op2 and op3 in FIG. 2(b) are abstracted away as a single UF s1. The figure also shows the correctness properties automatically placed by T-piper, which are used to decompose the verification problem into smaller sub-problems.

FIG. 21(b), FIG. 21(c), and FIG. 21(d) show the implementation models generated by T-piper to verify the pipelines in FIGS. 5A-C, respectively. In FIG. 21(b), the pipeline has no optimization. Thus, data hazards are resolved by stalling. Despite the simplicity, the pipeline still needs to implement a variety of control blocks (i.e., PstageCtrl, HazardMgr, PregsCtrl) for correctness. These control blocks are shown in white boxes in the figure. Also, although not shown in the figure, the read and write enables of state R are declared as free variables to make sure that all possible transaction sequences in the pipeline are explored. For the pipeline in FIG. 21(c), T-piper includes the forwarding paths and the necessary logic (FwdUnit) in the verification model. Additionally, the select signal for the multiplexer m1 is defined as a free variable, so that the model checker would explore all possible forwarding scenarios in the design. Although not shown, the models of FIG. 21(b) and FIG. 21(c) have coordination logic to stall the specification model when the implementation model stalls.

In FIG. 21(d), a predictor logic block pred is added to enable speculative execution, with the predicted value forwarded from stage 2 to stage 1, and the prediction resolved in stage 4. T-piper exposes the prediction forwarding path as well as the prediction resolution unit (PredResUnit). It also augments the model with (1) the isMispred free variable to emulate speculative execution; (2) the coordination logic to stall the specification model when the implementation is emulating a misprediction; and (3) the flag bits to track ‘shadow’ transactions in the pipeline.

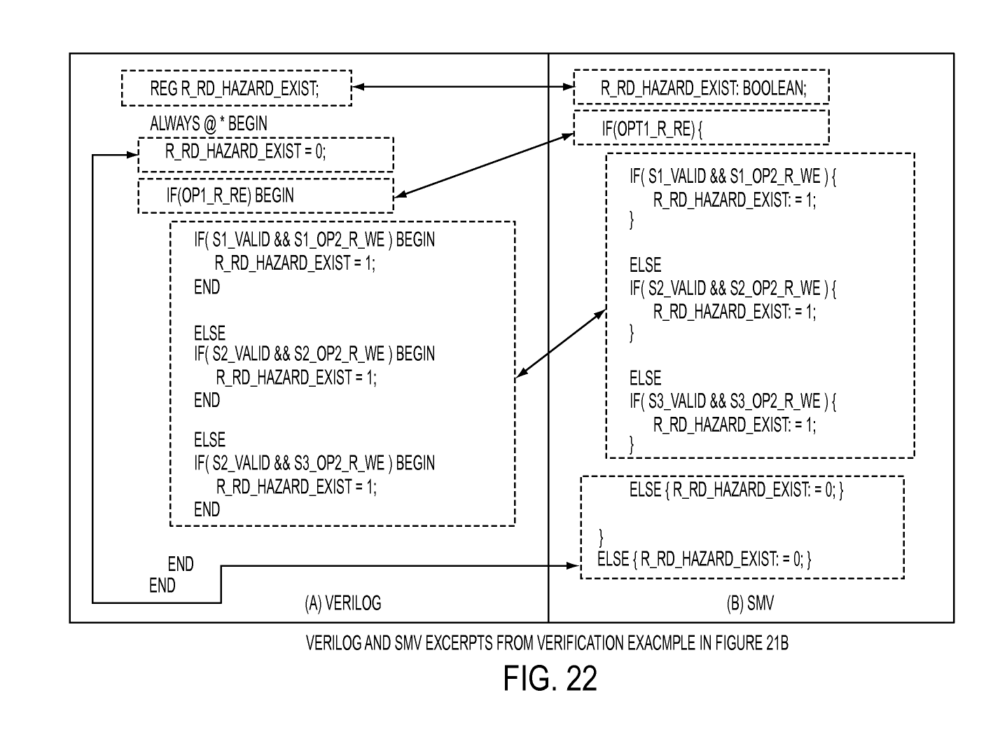

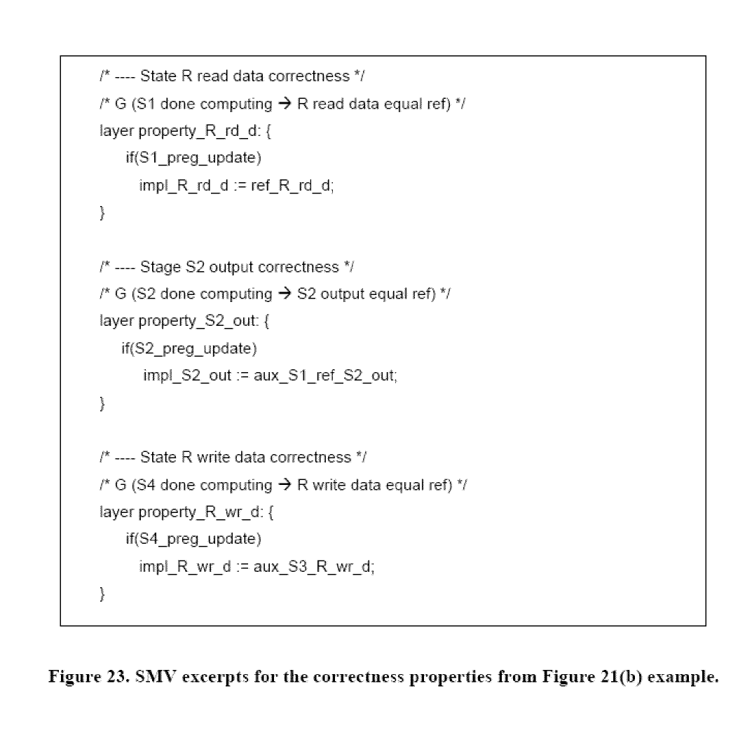

As mentioned previously, the Verilog and SMV descriptions of the implementation are generated from a common RTL internal representation at the final step of the synthesis process in various embodiments. Thus, both the Verilog and SMV descriptions contain the exact same pipelining logic, except that they are written in different syntax. FIG. 22 shows Verilog and SMV excerpts of the generated HazardMgr for the pipeline verification example in FIG. 21(b). The figure highlights the various parts of the excerpts, using the arrows to indicate the equivalent parts between the Verilog and SMV descriptions. In addition to the implementation model, the SMV file also contains the specification model, auxiliary states, coordination logic, and correctness properties to model check, as described in earlier sections. FIG. 23 shows an SMV excerpt for three generated correctness properties for the example in FIG. 21(b). The first property, property_R_rd_d, is of P-rd type to check the correctness of state R read data. The comment in the excerpt shows the temporal logic description of the property. The G is for “globally” operator, and the □ sign indicates “imply” relationship. For property_R_rd_d property, “G (S1 done computing→R read data equal ref)” says that at all time, a completion of stage S1 (where R read interface is) implies that the read data of R in the implementation model is equal to its reference value produced by the specification model. The other two properties are of types P-uf-out and P-wr, and they specify the correctness of pipeline stage S2 output and R write data, respectively.

In one general aspect, the present invention is directed to a computer-implemented method for synthesizing a hardware description for a pipelined datapath for a digital electronic circuit. The method may comprise the steps of receiving by a computer system a transaction-based specification for the datapath and one or more pipeline boundaries for the datapath. The transaction-based specification may comprise at least a first state element that comprises a read interface and a write interface (it may comprise other state elements as well that may or may not have the read and write interface). The transaction-based specification provides an abstract specification of a datapath that executes a sequence of transactions. The one or more pipeline boundaries define a plurality of stages, with the read and write interfaces of the first state element being assigned to one of the plurality of stages. In addition, the method may comprise the step of detecting, by the computer system, one or more data hazards in the datapath based on the transaction-based specification and the one or more pipeline boundaries when the transactions of the datapath are executed in a pipeline manner. The method may further comprise the step of determining, by the computer systems, whether the one or more detected data hazards are addressable by forwarding. The method may further comprise the step of determining, by the computer system, one or more valid forwarding opportunities in the datapath for each detected data hazard addressable by forwarding. The method may further comprise the step of, based on hazard resolution input responsive to the one or more valid forwarding opportunities, synthesizing, by the computer system, a pipelined hardware description for the datapath.

In various implementations, the read interface for the first state element has an associated read-enable control signal. In addition, the transaction-based specification may comprise (i) a plurality of state elements, (ii) a plurality of next state compute operations, and (iii) a plurality of logic block that implement the next state compute operations. The plurality of state elements may comprise the first state element. Each of the plurality of state elements has a read interface and a write interface. In addition, each of the read and write interfaces of the plurality of state elements are assigned to one of the plurality of stages, and each of the plurality of next state compute operations is assigned to one of the plurality of stages. In addition, the transaction-based specification may comprise at least one asynchronous next state logic block, in which case synthesizing the pipelined hardware description for the datapath may comprise mapping the at least one asynchronous next state logic block to a multi-cycle module.

In addition, the step of determining the one or more valid forwarding opportunities in the datapath may comprise identifying, by the computer system, a set of one or more forwarding points in the datapath. Identifying the set of one or more forwarding points in the datapath may comprise tracing a write-data signal for the first state element backwards across pipeline boundaries to find one or more points where the write-data signal and an accompanying write-enable signal associated with a write interface for the first state element are both available. In addition, determining the one or more valid forwarding opportunities in the datapath further may comprise determining that no other transactions between a read-point for the first state element and one of the one or more forwarding points write to the first state element.

In addition, the step of synthesizing the pipelined hardware description for the datapath may comprise incorporating a predicted value for a value of the datapath. The predicted value may comprise a next state predicted value for the first state element or a value for a control signal of the datapath. In addition, the step of synthesizing the pipelined hardware description for the datapath may comprise subsetting the datapath. Furthermore, the method may further comprise the step of verifying, by the computer system, functional equivalence of the pipelined hardware description after synthesis and the transaction-based specification. The step of verifying the functional equivalence may comprise using a compositional model checker. Also, the pipelined hardware description may comprise a RTL implementation of the datapath.

In another general aspect, the present invention is directed to a computer system for synthesizing a hardware description for a pipelined datapath for a digital electronic circuit. The computer system comprises at least one processor and at least one computer memory unit in communication with the at least one processor. The at least one computer memory unit stores software that when executed by the at least one processor causes the processor to receive a transaction-based specification for the datapath and one or more pipeline boundaries for the datapath. The transaction-based specification comprises at least a first state element that comprises a read interface and a write interface and provides an abstract specification of a datapath that executes a sequence of transactions. The one or more pipeline boundaries define a plurality of stages, with the read and write interfaces of the first state element being assigned to one of the plurality of stages. The at least one processor is also programmed to: (i) detect one or more data hazards in the datapath based on the transaction-based specification and the one or more pipeline boundaries when the transactions of the datapath are executed in a pipeline manner; (ii) determine whether the one or more detected data hazards are addressable by forwarding; (iii) determine one or more valid forwarding opportunities in the datapath for each detected data hazard addressable by forwarding; and (iv) based on hazard resolution input responsive to the one or more valid forwarding opportunities, synthesize a pipelined hardware description for the datapath.

In yet another general aspect, the present invention is directed to a computer readable medium having instructions stored thereon which, when executed by a processor, cause the processor to: (i) receive the transaction-based specification for the datapath and one or more pipeline boundaries for the datapath; (ii) detect, one or more data hazards in the datapath based on the transaction-based specification and the one or more pipeline boundaries when the transactions of the datapath are executed in a pipeline manner; (iii) determine whether the one or more detected data hazards are addressable by forwarding; (iv) determine one or more valid forwarding opportunities in the datapath for each detected data hazard addressable by forwarding; and (v) based on hazard resolution input responsive to the one or more value forwarding opportunities, synthesize a pipelined hardware description for the datapath.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of computer-readable media.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

A “computer,” “computer system,” “host,” “server,” or “processor” may be, for example and without limitation, a processor, microcomputer, minicomputer, server, mainframe, laptop, personal data assistant (PDA), wireless email device, cellular phone, pager, processor, fax machine, scanner, or any other programmable device configured to transmit and/or receive data over a network. Computer systems and computer-based devices disclosed herein may include memory for storing certain software modules used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable media.

In various embodiments disclosed herein, a single component may be replaced by multiple components and multiple components may be replaced by a single component to perform a given function or functions. Except where such substitution would not be operative, such substitution is within the intended scope of the embodiments. Any servers described herein, for example, may be replaced by a “server farm” or other grouping of networked servers (such as server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand and/or providing backup contingency in the event of component failure or reduction in operability.

The computer systems may comprise one or more processors in communication with memory (e.g., RAM or ROM) via one or more data buses. The data buses may carry electrical signals between the processor(s) and the memory. The processor and the memory may comprise electrical circuits that conduct electrical current. Charge states of various components of the circuits, such as solid state transistors of the processor(s) and/or memory circuit(s), may change during operation of the circuits.

While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

What is claimed is:

1. A computer-implemented method for synthesizing a hardware description for a pipelined datapath for a digital electronic circuit, the method comprising:
receiving by a computer system a transaction-based specification for the datapath and one or more pipeline boundaries for the datapath, wherein:
the transaction-based specification comprises at least a first state element that comprises a read interface and a write interface;
the transaction-based specification provides an abstract specification of a datapath that executes a sequence of transactions;
the one or more pipeline boundaries define a plurality of stages, with the read and write interfaces of the first state element being assigned to one of the plurality of stages;
detecting, by the computer system, one or more data hazards in the datapath based on the transaction-based specification and the one or more pipeline boundaries when the transactions of the datapath are executed in a pipeline manner;
determining, by the computer systems, whether the one or more detected data hazards are addressable by forwarding;
determining, by the computer system, one or more valid forwarding opportunities in the datapath for each detected data hazard addressable by forwarding; and
based on hazard resolution input responsive to the one or more valid forwarding opportunities, synthesizing, by the computer system, a pipelined hardware description for the datapath.

2. The method of claim 1, wherein the read interface for the first state element has an associated read-enable control signal.

3. The method of claim 1, wherein:
the transaction-based specification comprises a plurality of state elements, a plurality of next state compute operations, and a plurality of logic block that implement the next state compute operations;
the plurality of state elements comprises the first state element;
each of the plurality of state elements has a read interface and a write interface; and
each of the read and write interfaces of the plurality of state elements are assigned to one of the plurality of stages, and each of the plurality of next state compute operations is assigned to one of the plurality of stages.

4. The method of claim 3, wherein the read interface for the first state element has an associated read-enable control signal.

5. The method of claim 3 wherein:
the transaction-based specification comprises at least one asynchronous next state logic block; and
synthesizing the pipelined hardware description for the datapath comprises mapping the at least one asynchronous next state logic block to a multi-cycle module.

6. The method of claim 1, wherein:
the transaction-based specification comprises at least one asynchronous next state logic block; and
synthesizing the pipelined hardware description for the datapath comprises mapping the at least one asynchronous next state logic block to a multi-cycle module.

7. The method of claim 1, wherein determining the one or more valid forwarding opportunities in the datapath comprises identifying, by the computer system, a set of one or more forwarding points in the datapath.

8. The method of claim 7, wherein:
identifying the set of one or more forwarding points in the datapath comprises tracing a write-data signal for the first state element backwards across pipeline boundaries to find one or more points where the write-data signal and an accompanying write-enable signal associated with a write interface for the first state element are both available; and
determining the one or more valid forwarding opportunities in the datapath further comprises determining that no other transactions between a read-point for the first state element and one of the one or more forwarding points write to the first state element.

9. The method of claim 1, wherein
synthesizing the pipelined hardware description for the datapath comprises incorporating a predicted value for a value of the datapath.

10. The method of claim 9, wherein the predicted value comprises a next state predicted value for the first state element.

11. The method of claim 9, wherein the predicted value comprises a value for a control signal of the datapath.

12. The method of claim 1, wherein synthesizing the pipelined hardware description for the datapath comprises subsetting the datapath.

13. The method of claim 1, further comprising verifying, by the computer system, functional equivalence of the pipelined hardware description after synthesis and the transaction-based specification.

14. The method of claim 13, wherein verifying the functional equivalence comprises using a compositional model checker.

15. The method of claim 1, wherein the pipelined hardware description comprises a RTL implementation of the datapath.

16. A computer system for synthesizing a hardware description for a pipelined datapath for a digital electronic circuit, the computer system comprising:
at least one processor; and
at least one computer memory unit in communication with the at least one processor, wherein the at least one computer memory unit stores software that when executed by the at least one processor causes the processor to:
receive a transaction-based specification for the datapath and one or more pipeline boundaries for the datapath, wherein:
the transaction-based specification comprises at least a first state element that comprises a read interface and a write interface;
the transaction-based specification provides an abstract specification of a datapath that executes a sequence of transactions;
the one or more pipeline boundaries define a plurality of stages, with the read and write interfaces of the first state element being assigned to one of the plurality of stages;
detect one or more data hazards in the datapath based on the transaction-based specification and the one or more pipeline boundaries when the transactions of the datapath are executed in a pipeline manner;
determine whether the one or more detected data hazards are addressable by forwarding;
determine one or more valid forwarding opportunities in the datapath for each detected data hazard addressable by forwarding; and
based on hazard resolution input responsive to the one or more valid forwarding opportunities, synthesize a pipelined hardware description for the datapath.

17. The computer system of claim 16, wherein the read interface for the first state element has an associated read-enable control signal.

18. The computer system of claim 16, wherein:
the transaction-based specification comprises a plurality of state elements, a plurality of next state compute operations, and a plurality of logic block that implement the next state compute operations;
the plurality of state elements comprises the first state element;
each of the plurality of state elements has a read interface and a write interface; and
each of the read and write interfaces of the plurality of state elements are assigned to one of the plurality of stages, and each of the plurality of next state compute operations is assigned to one of the plurality of stages.

19. The computer system of claim 18, wherein the read interface for the first state element has an associated read-enable control signal.

20. The method of claim 18, wherein:
the transaction-based specification comprises at least one asynchronous next state logic block; and
the at least one processor synthesizes the pipelined hardware description for the datapath by mapping the at least one asynchronous next state logic block to a multi-cycle module.

21. The method of claim 16, wherein:
the transaction-based specification comprises at least one asynchronous next state logic block; and
the at least one processor synthesizes the pipelined hardware description for the datapath by mapping the at least one asynchronous next state logic block to a multi-cycle module.

22. The computer system of claim 16, wherein the at least one processor determines the one or more valid forwarding opportunities in the datapath by identifying a set of one or more forwarding points in the datapath.

23. The computer system of claim 22, wherein the at least one processor:
identifies the set of one or more forwarding points in the datapath by tracing a write-data signal for the first state element backwards across pipeline boundaries to find one or more points where the write-data signal and an accompanying write-enable signal associated with a write interface for the first state element are both available; and
determines the one or more valid forwarding opportunities in the datapath by determining that no other transactions between a read-point for the first state element and one of the one or more forwarding points write to the first state element.

24. The computer system of claim 16, wherein the at least one processor synthesizes the pipelined hardware description for the datapath by incorporating a predicted value for a value of the datapath.

25. The computer system of claim 24, wherein the predicted value comprises a next state predicted value for the first state element.

26. The method of claim 24, wherein the predicted value comprises a value for a control signal of the datapath.

27. The method of claim 16, wherein synthesizing the pipelined hardware description for the datapath comprises subsetting the datapath.

28. The computer system of claim 16, wherein the at least one processor is further programmed to verify functional equivalence of the pipelined hardware description after synthesis and the transaction-based specification.

29. The computer system of claim 28, wherein the at least one processor verifies the functional equivalence using a compositional model checker.

30. The computer system of claim 16, wherein the pipelined hardware description comprises a RTL implementation of the datapath.

31. A computer readable medium having instructions stored thereon which, when executed by a processor, cause the processor to:
receive a transaction-based specification for the datapath and one or more pipeline boundaries for the datapath, wherein:
the transaction-based specification comprises at least a first state element that comprises a read interface and a write interface;
the transaction-based specification provides an abstract specification of a datapath that executes a sequence of transactions;
the one or more pipeline boundaries define a plurality of stages, with the read and write interfaces of the first state element being assigned to one of the plurality of stages;
detect, one or more data hazards in the datapath based on the transaction-based specification and the one or more pipeline boundaries when the transactions of the datapath are executed in a pipeline manner;
determine whether the one or more detected data hazards are addressable by forwarding;
determine one or more valid forwarding opportunities in the datapath for each detected data hazard addressable by forwarding; and
based on hazard resolution input responsive to the one or more value forwarding opportunities, synthesize a pipelined hardware description for the datapath.
